(19) United States
(12) Patent Application Publication
(10) Pub. No.: US 2012/0308789 A1
(43) Pub. Date: Dec. 6, 2012

(54) Multilayer Films Having Improved Imageability,Their Methods of Manufacture, and Articles Made Therefrom

(76) Inventors: Mark W. Lockhart, Fairport, NY (US); David A. Liestman, Walworth, NY (US); George F. Cretekos, Farmington, NY (US); Pang-Chia Lu, Pittsford, NY (US)

(21) Appl. No.: 13/531,026

(22) Filed: Jun. 22, 2012

Related U.S. Application Data
(63) Continuation-in-part of application No. 13/002,886, filed on Feb. 17, 2011.

(51) Int. Cl. B32B 27/32; B32B 27/30; B32B 27/36; B29C 47/06; B05D 3/00

(52) U.S. Cl. 428/203; 264/173.19; 427/322; 428/523; 428/522

(57) ABSTRACT

Imageable multilayer films are provided which include at least a core layer comprising a pigment or other colorant, a clear sealant layer, and an image-side tie layer intermediate the core layer and the sealant layer, where the tie layer comprises a cavitating agent. The sealant layer may include a first polymer component having a heat of fusion of less than 75 J/g and a second polymer component. The multilayer film may have a seal strength greater than about 200 g/2.54 cm for a seal formed on a crimp sealer at a temperature of at least 93.3° C. The multilayer film may be biaxially oriented, an image may be effected on the film without the use of inks, and the film may be useful in packaging applications.

### CROSS-REFERENCE TO RELATED APPLICATIONS

For purposes of U.S. patent practice, the present application is a continuation-in-part of, and claims priority to U.S. Ser. No. 13/002,886 filed Jan. 2, 2011, which claims priority to U.S. Ser. No. 61/079,466 filed on Jul. 10, 2008, each of which is incorporated by reference.

### FIELD OF THE INVENTION

This disclosure relates to heat-sealable and/or imageable multilayer films. In particular, this disclosure relates to such multilayer films that are oriented and have improved sealing and/or imaging properties.

### BACKGROUND OF THE INVENTION

Polyolefin multilayer films, especially polypropylene based films, are widely used in packaging applications, such as pouches for dry food mixes, pet foods, snack foods, and seeds. In many film applications it is desirable to seal the film during the packaging operation. This may be accomplished by the use of adhesives or by using heat sealing techniques. When heat sealing is used, it is important that the plastic film be readily heat sealable while also possessing other good physical and mechanical properties such as resistance to tearing, high tensile strength, and good processability in high speed equipment. Such multilayer films preferably have the ability to form strong seals at relatively low temperatures and, in some instances, the ability to do so in the presence of contamination in the seal region from the contents of the pouches.

U.S. Pat. No. 7,537,829 discloses multilayer film wherein a soft polymer is blended in a core layer and a tie layer comprising the soft layer and, optionally, another polymer. A sealable layer is provided on the side of the tie layer opposite the core layer. The multilayer films may be transparent, contain a cavitating agent, or are pigmented to form an opaque film. Also, the multilayer film may be metallized or coated with a barrier coating.

U.S. Pat. No. 6,844,078 discloses a co-extruded multilayer film, having of at least a high crystalline propylene homopolymer resin layer of isotactic content greater than about 95%; a discharge-treated surface on one side of said polyolefin resin layer, an amount of hydrocarbon resin up to 10% by weight of the high crystalline propylene homopolymer of greater than about 95% isotactic content; and on the high crystalline propylene homopolymer resin layer side opposite said discharge-treated surface, a heat sealable or winding layer having an antiblock.

An imageable film is also desirable, especially one that does not require post-coating treatments to make the surface imageable, and is also lighter and less expensive. Disclosures related to printability or imageability are U.S. Pat. No. 8,054,323, which is related to opaque polymers on the surface of a film that are sensitive to heat and/or pressure to provide a means for printing; U.S. Patent Application Publication 2003-0021981 A1; U.S. Pat. Nos. 4,758,462; 5,443,915; 8,088,474; and EP 0 865 911 A1. By “imageable” what is meant is a film wherein images (e.g., lettering, designs) can be effected by causing the coloring or clarity located beneath a cavitated region or layer to become visible to form such images.

There is still a need for a film with improved seal strength, hermeticity, hot tack, and reduced sealing temperatures as well as imageability. Opportunities exist for polymer films to replace other packaging substrates, such as paper and foil, in many temperature-sensitive packaging operations, such as with ice cream bars, chocolate bars, and dry-particulate foods. In particular, there is a need for such a film that can be used in high-speed packaging equipment. The inventors have surprisingly found that the application of heat or pressure to a sealable film also has other implications. The inventors have surprisingly found that an image can be effected in a film having a desirable protective/cavitated/colored multilayered structure.

### SUMMARY OF THE INVENTION

The present disclosure relates to multilayer films having improved low temperature sealing properties, improved seal strength, and an improved ability to affect an image in the film, or “imageability.” The multilayer film may comprise an arrangement of co-extruded polymeric layers that contribute individually and collectively to improving sealing strength, impact strength, resilience, hermeticity, reduced-temperature sealability, and improved imageability of the film. In another aspect, the multilayer film comprises at least a core layer and a sealant layer, and optionally one or more tie layers and/or an outer skin layer.

Described herein are imageable multilayer films comprising a polypropylene core layer that is clear or comprises a pigment or colorant; a clear sealant layer through which an image may be visible; and at least one image-side tie layer, wherein the image-side tie layer is intermediate of the core layer and the sealant layer and comprises a cavitating agent.

Also disclosed is a method forming an image on a multilayer film comprising (or consisting essentially of, or consisting of) the steps of co-extruding at least, a core layer; a sealant layer; and an image-side tie layer, wherein the image-side tie layer is intermediate the core layer and the sealant layer; and orienting said co-extruded multilayer film in at least one direction; and imparting selective physical or thermal treatment to the image-side of the film to effect an image thereon.

### DETAILED DESCRIPTION OF THE INVENTION

Direct thermal printing and thermal printing technologies rely on coatings today to effectuate the image as a function of heat and pressure. The coatings and ribbon ink are not durable, are expensive, and require multiple steps to build the final printed image. This adds complexity, cost, and reduces reliability. To solve the problems with conventional technology, the inventors have found that an image layer can be “buried” within a co-extruded film. Such image layer containing a pigment is covered with a cavitated or voided layer that is white and opaque. Upon passing through, for example, a physical impacting device, a thermal print device, ultrasound print device or laser, the patterned heat will effect an image by collapsing the voids rendering the layer transparent and creating the image. The collapsed areas where an image is effected will be much thinner than the surrounding regions of the layer containing the cavitation agent, preferably the image-side tie layer, and may be within the range from 0.1% or 0.5% or 1% or 5% to 6% or 10% or 15% of the original thickness of the image-side tie layer. A thin sealant layer can be co-extruded on top of the voided layer, preferably a tie layer comprising a cavitation agent, to protect the voided layer and the pigment layer. In essence, the imageable substrate is created in one step on the film orienter. This solves the problem of durability, significantly reduces the cost of the process, and increases the reliability of the system creating a much better solution to the problem than conventional coating technologies.

Thus, a preferred arrangement of such technology comprises a multilayered film having an A/B/C structure comprising at least a pigmented or “core layer” “C”, a voided or “tie layer” “B” comprising cavitation agents, and a protective or “sealant layer” “A” with the tie layer between the core and sealant layers. Functionally, the layers impart protection/cavities/color and can desirably be co-extruded layers of polymer or polymer mixtures. Other layers may be present, for example, there may be two core layers with only one comprising the pigment, colorant, or opacifying agent. Another preferable structure for the multilayered film is an A/B/C/D/E structure, wherein the “E” layer is a second skin that can be sealable, printable, and/or metalizable. The “D” layer may be a first core layer that is voided or otherwise includes fillers to make it opaque, and a pigmented tie layer “C”, with a first tie layer “B” having cavitating agents therein, with a sealant layer “A”. In an alternative structure, a colored coating or metal coating may be applied to the multilayered film on the outside “E” skin layer in addition to, or instead of, pigment or colorant in the “C” and/or “D” layers.

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, “polymer” may be used to refer to homopolymers, copolymers, interpolymers, terpolymers, etc.

As used herein, “isotactic” is defined as polymeric stereoregularity having at least 40% isotactic pentads of methyl groups derived from propylene according to analysis by ¹³C-NMR.

As used herein, “stereoregular” is defined to mean that the predominant number, e.g., greater than 80%, of the propylene units in the polypropylene or in the polypropylene continuous phase of a blend, such as impact copolymer exclusive of any other monomer such as ethylene, has the same 1,2 insertion and the stereochemical orientation of the pendant methyl groups is the same, either meso or racemic.

As used herein, “intermediate” is defined as the position of one layer of a multilayer film wherein said layer lies between two other identified layers. In some embodiments, the intermediate layer may be in direct contact with either or both of the two identified layers. In other embodiments, additional layers may also be present between the intermediate layer and either or both of the two identified layers.

As used herein, “substantially free” is defined to mean that the referenced film layer is largely, but not necessarily wholly, absent a particular component. In some embodiments, the layer is completely free of the particular component; however, in other embodiments, small amounts of the component may be present within the referenced layer as a result of standard manufacturing methods, including recycling of film scraps and edge trim during processing. “Substantially absent” means that the particular component is not purposefully added to the named mixture/blend, or if present, only to a level of less than 1 wt % or less than 0.5 wt % of the mixture/blend.

The terms “compliant” or “compliance” as used herein refer to the ability of the sealed area of film to deform or conform within the sealing jaws during sealing operations and additionally to elastically and/or plastically deform and diffuse stress throughout the multilayer film substrate subsequent to sealing operations when the seal is subjected to stress.

The multilayer film comprises a core layer and a sealant layer, wherein the sealant layer comprises a blend of a first polymer component (“FPC”) and a second polymer component (“SPC”). The core layer may comprise a nucleating agent and a hydrocarbon resin. The multilayer film may further comprise one or more tie layers, an outer skin layer, and may be metallized.

A SPC is blended or provided in the sealant layer to facilitate improved seal strengths and, in some embodiments, low-temperature sealing properties. The multilayer film comprises the SPC as a fractional component of the sealant layer. The SPC may be considered a softening or compliance-enhancing additive. The presence of the SPC may allow the film's layers to act synergistically with each other to dissipate stress throughout the layers when subjected to the pressures of sealing jaws and when subjected to subsequent stresses on the seal, such as seal opening forces. When force is applied to a seal of the sealant layer to itself, the film diffuses or dissipates the stress throughout each of the layers through improved plastic deformation or compliance, instead of leaving the stress concentrated in the seal layer. A seal that dissipates the stress may generally facilitate a stronger seal than the same film having a concentrated stress region. Furthermore, when a very localized force (with or without heat) is imparted to the surface of a multilayered film having a color/cavity/protection structure, such as an embossing or laser in the form of a letter and/or picture, an image is effected that is visible through the film's surface.

The seal strength may be enhanced by reducing the modulus of the sealant layer and improving the melt or flow characteristics of the layer during sealing. Improved seal strength may be realized through improved bonding interaction between the film's layers. It is believed that decreasing the melt temperature of the sealant layer may increase the degree of entanglement and intermingling of the adjacent layer thus resulting in improved bonding at the interface of the layers adjacent to SPC-containing layers. Benefits of the improved flowability may manifest film improvements during co-extrusion of the multilayer film and then again during sealing operations.

As a result of the improved elasticity or compliance, the films may also provide improvements in seal strength integrity and improved hermetic sealing, particularly in the more leak-prone folds, creases, and seams in the seal area, due to the improved film conformability during sealing. A hermetic seal is a seal that does not allow the passage of gas, such as air.

In a preferred embodiment, a thin gauge multilayer film is provided that is suitable for packaging applications. Preferably the total thickness of the multilayer film is in the range of about 5 μm to about 60 μm, or in the range of about 10 μm to about 35 μm, or more preferably in the range of about 15 μm to about 30 μm, or in the range of about 12 μm to about 20 μm, or preferably in the range of about 15 μm to about 18 μm. Additionally, the multilayer film preferably has a minimum seal temperature and hot tack strength so that it is suitable for packaging applications, such as food packaging.

The desired minimum seal temperature (“MST”) may depend on the end use application of the film, for example, for chocolate bars the MST may be the temperature at which the seal strength is 200 g, for potato chips in the United States the desired MST may be the temperature at which the seal strength is 500 g, and for potato chips in Asia the MST may be the temperature at which the seal strength is 1000 g. The MST may also depend on the type of seal used, e.g., a fin seal vs. crimp seal. As used herein, the MST is the sealing temperature when the seal strength reaches 200 g of peeling force on a 1 inch (2.54 cm) wide film sample when tested at 60 psi seal pressure, 0.75 seconds of dwell time, and 20 seconds of cooling time with a vertical seal jaw. The multilayer films described herein preferably have a MST of less than or equal to about 200° F. (93° C.), more preferably less than or equal to about 190° F. (88° C.), even more preferably less than or equal to about 186° F. (86° C.).

The seal strength of the multilayer film may be greater than about 200 grams/2.54 cm, or greater than about 300 grams/2.54 cm, when seals are formed using a crimp sealer at a temperature of at least 190° F. (87.8° C.). The film will preferably have a seal strength of greater than about 200 g/2.54 cm, or 250 g/2.54 cm, or 300 g/2.54 cm for a seal formed on a crimp sealer at a temperature of at least 200° F. (93.3° C.). In some embodiments, the film will have a seal strength of at least 400 grams/inch when sealed at a temperature of at least 200° F. (93.3° C.).

### First Polymer Component

The first polymer component (“FPC”) typically includes at least one polymer that is suitable for heat-sealing or bonding, when crimped between heated crimp-sealer jaws, fin, or lap sealing jaws. Suitable FPCs may include copolymers or terpolymers of ethylene, propylene.

Preferably, the first polymer component comprises a polymer that has a reduced melting temperature, as compared to more crystalline polymers. A lower crystallinity (and, thus, lower specific heat of fusion (ΔH)) material is desired as they generally provide better sealability. In a preferred embodiment, the FPC has a ΔH of less than about 80 J/g, or more preferably less than about 75 J/g. Preferred FPCs have a ΔH in the range of about 40 J/g to about 80 J/g, or more preferably in the range of about 50 J/g to about 75 J/g.

The FPC may be a propylene homopolymer, a copolymer or terpolymer of propylene, or a mixture thereof. The FPC can be manufactured in any conventional manner using Ziegler-Natta or metallocene catalysts or any other suitable catalyst system.

Suitable FPCs may include, but are not limited to, propylene homopolymer, ethylene-propylene copolymer, butylene homopolymer and copolymers, ethylene-propylene-butylene (“EPB”) terpolymer, ethylene vinyl acetate (“EVA”), metallocene-catalyzed propylene homopolymer, and combinations thereof.

The sealant layer may additionally or alternatively include at least one of ethylene-propylene random copolymers, LDPE, linear low density polyethylene (LLDPE), medium density polyethylene (MDPE), and combinations thereof.

Examples of suitable commercially available FPCs include: JPC 7794 and JPC 7510 both EPB terpolymers available from Japan Polypropylene Corp; EP-8573 an EP copolymer available from Total Petrochemical Company; PB0300M available from LyondellBasell; and Adsyl 3C30FHP available from LyondellBasell.

### Second Polymer Component

The second polymer component (“SPC”) includes polymer resins that are less stiff, have lower modulus, are more flexible and elastic, and tend to have a more plastic stress-strain behavior than the more common polymer film-forming resins such as isotactic polypropylene and high-density polyethylene. Acceptable SPCs include, but are not limited to, resins having more elastic or amorphous-type functional properties as opposed to more crystalline properties.

The SPC may improve the compliance or resilience of the layer in which it is included, both during and after sealing. Examples of suitable SPCs include impact and block copolymers, cross-linked polymers, metallocene catalyzed random copolymers, syndiotactic propylene, polypropylene, metallocene catalyzed polypropylene, random and mini-random propylene copolymers, polyethylene, and other polymers having reduced modulus or improved elastic properties as compared to more crystalline polymers, such as isotactic polypropylene or high density polyethylene, which do not qualify as acceptable SPCs.

The SPC may have a density in the range of 0.850 g/cm³ to 0.920 g/cm³, preferably in the range of 0.850 g/cm³ to 0.900 g/cm³, more preferably in the range of 0.870 g/cm³ to 00.885 g/cm³.

The SPC may have a melting point temperature, as measured by DSC as described below, in the range of 40° C. to 160° C., more preferably in the range of 60° C. to 120° C. In some preferred embodiments, the SPC will be a polyolefin co- or terpolymer and may have a melting point temperature (Tₘ) equal to or less than about 140° C., or equal to or less than about 120° C., and for some embodiments, equal to or less than about 100° C.

In some embodiments, the SPC has a propylene content in the range of 75 wt % to 96 wt %, preferably in the range of 80 wt % to 95 wt %, more preferably in the range of 84 wt % to 94 wt %, most preferably in the range of 85 wt % to 92 wt %, and an ethylene content in the range of 4 wt % to 25 wt %, or in the range of 5 wt % to 20 wt %, preferably in the range of 6 wt % to 16 wt %, more preferably in the range of 8 wt % to 15 wt %.

The SPC may have a flexural modulus of not more than 2100 MPa, preferably not more than 1500 MPa, more preferably in the range of 20 MPa to 700 MPa. The SPC will most commonly include those polymers having a flexural modulus (ASTM D790) of less than about 550 MPa. Preferably, the SPC include those polymers having a flexural modulus of less than about 350 MPa, and, for some embodiments, less than about 150 MPa.

In some embodiments, the SPC has a MFR in the range of 2 dg/min. to 100 dg/min., preferably in the range of 5 dg/min. to 50 dg/min., more preferably in the range of 5 dg/min. to 25 dg/min., most preferably in the range of 5 dg/min. to 10 dg/min.

The SPC may further have a molecular weight distribution (MWD) less than 7.0, or preferably less than or equal to 3.2. The SPC may have a MWD in the range of 1.8 to 5.0, or preferably 2.0 to 3.2.

The elongation of the SPC is preferably at least 300%, more preferably at least 400%, even more preferably at least 500%, and most preferably greater than 1000%. In some cases, elongations of 2000% or more are possible.

The heat of fusion of the SPC is preferably less than 75 J/g.

In some embodiments, the SPC has isotactic stereoregular crystallinity. In other embodiments, the first polymer has a crystallinity in the range of 2% to 65%.

The SPC may be produced via a single site catalyst polymerization process. In some embodiments, the single site catalyst incorporates hafnium.

The SPC may also be defined as those resins having a Vicat softening point (ASTM D1525) of less than or equal to about 105° C., more preferably of less than or equal to about 80° C., and for some embodiments, most preferably of less than or equal to about 66° C.

In one embodiment, the SPC includes those homopolymers, copolymers, terpolymers, or other polymers having at least one of the following properties:
(a) Melting point temperature, “Tₘ” less than or equal to about 142° C.;
(b) Vicat Softening Point (ASTM D1525) of less than or equal to about 105° C.; and/or
(c) Flexural Modulus (ASTM D790) of less than or equal to about 550 MPa.

In another embodiment, the SPC includes those polymers having at least one of the following sets of properties:
(a) Density in the range of 0.850 g/cm³ to 0.920 g/cm³, a DSC melting point in the range of 40° C. to 160° C., and a MFR in the range of 2 dg/min. to 100 dg/min.;
(b) A propylene-ethylene copolymer including from about 75 wt % to about 96 wt % propylene, about 4 wt % to about 25 wt % ethylene, and having a density in the range of 0.850 g/cm³ to 0.900 g/cm³;
(c) A flexural modulus of less than 2100 MPa and an elongation of at least 300%;
(d) Isotactic stereoregularity, from about 84 wt % to about 93 wt % propylene, from about 7 wt % to about 16 wt % ethylene, a DSC melting point in the range of about 42° C. to about 85° C., a heat of fusion less than 75 J/g, crystallinity of about 2% to about 65%, and a MWD of about 2.0 to about 3.2;
(e) A polymer blend, comprising at least one polymer (A) and at least one polymer (B), polymer (A) comprising about 60 wt % to about 98 wt % of the blend, and polymer (A) comprising about 82 wt % to about 93 wt % of units derived from propylene and about 7 wt % to 18 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A); and
(f) A polymer blend, comprising at least one polymer (A) and at least one polymer (B), polymer (A) comprising about 60 wt % to about 98 wt % of the blend, and polymer (A) comprising about 65 wt % to about 96 wt % of units derived from propylene and about 4 wt % to about 35 wt % of units derived from a comonomer selected from the group consisting of ethylene and an unsaturated monomer other than ethylene, and polymer (A) is further characterized as comprising crystallizable propylene sequences, and polymer (B) comprising an isotactic thermoplastic polymer other than polymer (A).

Preferably, the SPC comprises C₂C₃ random copolymers, C₂C₃C₄ random terpolymers, heterophasic random copolymers, C₄ homopolymers, C₄ copolymers, metallocene polypropylenes, propylene-based or ethylene-based elastomers and/or plastomers, or combinations thereof. In preferred embodiments, the SPC has a density in the range of 0.850 g/cm³ to 0.920 g/cm³, a DSC melting point in the range of 40° C. to 160° C., and a MFR in the range of 2 dg/min. to 100 dg/min.

For further example, other acceptable SPCs include, but are not limited to, impact copolymers or heterophasic polymer blends that typically contain from about 5 to 25 percent by weight of an elastomeric compound to incorporate rubber-like properties to the normally rigid backbone of polypropylene-based polymers. Other heterophasic copolymers, such as those made by LyondellBasell's Catalloy™ process may contain over 25 weight percent and even in excess of 50 weight percent of elastomeric compound. For the exemplary Catalloy™ or impact polymers, the elastomeric component of the impact polymer may include, but are not limited to, acrylonitrile-chloroprene copolymer, acrylonitrile-isoprene copolymer, butadiene-acrylonitrile copolymer, chlorinated polyethylene, chlorosulfonated polyethylene, ethylene-ether polysulfite, ethylene-ethyl acrylate copolymer, ethylene polysulfite, ethylene-propylene copolymer, ethylene-propylene-diene terpolymer, fluoroelastomer, fluorosilicone, hexafluoropropylene-vinylidene fluoride copolymer, isobutene-isoprene copolymer, organopolysiloxane, acrylic ester-butadiene copolymer, polybutadiene, polychloroprene, polyepichlorohydrin, polyisobutene, polyisoprene, polyurethane, styrene-butadiene copolymer, styrene-chloroprene copolymer, polyethylene-butyl graft copolymer, styrene-butadiene-styrene triblock polymer, and blends thereof.

The other polymer component of the exemplary heterophasic copolymers may include, for example, ethylene- and propylene-based polymers including, but not limited to, polyolefins selected from the group consisting of propylene (PP) homopolymer, ethylene-propylene (EP) copolymer, ethylene-propylene-butylene (EPB) terpolymer, propylene-butylene (PB) copolymer, and blends thereof.

Other acceptable SPCs may include block copolymers, copolymers and terpolymers including C₂-C₈ alpha-olefins, and random copolymers. The SPCs may be the product of Ziegler-Natta or metallocene catalysis.

In one embodiment, the SPC may include an ethylene-propylene copolymer which has been crosslinked and is blended into a propylene matrix.

The SPC may include one or more of the following commercially available polymers: grades of Vistamaxx™ such as VM6100 and VM3000 (available from ExxonMobil Chemical Company); Versify™ (available from The Dow Chemical Company); LyondellBasell Catalloy™ resins such as Adflex™ T100F, Softell™ Q020F, Clyrell™ SM1340 (available from LyondellBasell Polyolefins); propylene-butene-1 random copolymers such as LyondellBasell PB 8340 (available from LyondellBasell Polyolefins); Borealis Borsoft™ SD233CF (available from Borealis); Exceed™ 1012CA and 1018CA metallocene polyethylenes, Exact™ 5361, 4049, 5371, 8201, 4150, 3132 polyethylene plastomers, EMCC 3022.32 low density polyethylene (LDPE) (all available from ExxonMobil Chemical Company); Total Polypropylene 3371 polypropylene homopolymer (available from Total Petrochemicals); JPC 7500 and JPC XPM 7800 both EPB terpolymers (available from Japan Polypropylene Corporation); and PB copolymer such as Shell SRD4-141 (available from Shell Chemical Company).

### Sealant Layer

The sealant layer is generally one of the outermost layers of the multilayer film and may be used to form a seal. The seal may be heat-sealable, pressure-sealable, or may include a sealing agent such as an adhesive. Preferably, the sealant layer is transparent, thus allowing colorant or pigments located in the core layer to be selectively seen upon activation of selected regions of the cavitated image-side tie layer. Preferably, the sealant layer can be described as having a Haze Value (ASTM D1003) of less than 10% or 8% or 5% or 2%. While the term “sealant skin” is used to describe this layer, an adhesive is not required. Preferably the sealant layer is heat sealable and includes polymers that are suitable for heat-sealing or bonding to itself when crimped between heated crimp-sealer jaws.

The sealant layer comprises at least one first polymer component (“FPC”), as described above, and at least one second polymer component (“SPC”), as described above. In some embodiments of this disclosure, the sealant layer is contiguous to the core layer. In other embodiments, one or more other layers may be intermediate the core layer and the sealant layer.

Heat sealable blends may be utilized in the sealant layer. The sealant layer may comprise up to about 95 wt % of the FPC, or up to about 80% of the FPC based on the total weigh of the sealant layer. In other embodiments, the sealant layer may comprise from about 10 wt % to about 55 wt % of the FPC, or from about 20 wt % to about 60 wt % of the FPC, or from about 30 wt % to about 75 wt % of the FPC, or in preferred embodiments from about 45 wt % to about 80 wt % of the FPC, and most preferably from about 60 wt % to about 95 wt % of the FPC based on the total weight of the sealant layer.

In preferred embodiments, the sealant layer comprises 50 wt % or less of the SPC, or 40 wt % or less of the SPC, based on the total weight of the sealant layer. In other embodiments, the sealant layer may comprise from about 5 wt % to about 50 wt % of the SPC, or from about 10 wt % to about 40 wt % of the SPC, or preferably from about 10 wt % to about 35 wt % of the SPC, based on the total weight of the sealant layer. Generally the sealant layer does not contain more than 50 wt %, or more than 40 wt %, of the SPC as greater amounts of SPC may lead to roll sticking due to the lower melting temperature/softness of the SPC during machine direction orientation in the biaxial orientation process.

In some embodiments, the sealant layer may further comprise processing aids or one or more additives such as opacifying agent, slip agents, anti-static agents, anti-block agents, and combinations thereof but most preferably excludes opacifying agents, coloring agents and/or pigments so that the sealant layer is clear (low Haze).

The thickness of the sealant layer is typically in the range of about 0.10 μm to 7.0 μm, preferably about 0.10 μm to 4 μm, and most preferably about 0.10 μm to 3 μm. In some film embodiments, the sealant layer thickness may be in the range of about 0.10 μm to 2 μm, or 0.10 μm to 1 μm, or 0.10 μm to 0.50 μm. In some commonly preferred film embodiments, the sealant layer has a thickness in the range of about 0.5 μm to 2 μm, 0.5 μm to 3 μm, or 1 μm to 3.5 μm.

### Core Layer

The core layer of a multilayer film is most commonly the thickest layer of the film and provides the foundation of the multilayer structure. In some embodiments, the core layer may comprise a propylene polymer, ethylene polymer, isotactic polypropylene (“iPP”), high crystallinity polypropylene (“HCPP”), low crystallinity polypropylene, isotactic and syndiotactic polypropylene, ethylene-propylene (“EP”) copolymers, and combinations thereof.

In a preferred embodiment, the core layer is an iPP homopolymer. Examples of suitable commercially available iPP include: PP4712E1 from ExxonMobil Chemical Company, and Total Polypropylene 3371 from Total Petrochemicals. An example of a useful HCPP is Total Polypropylene 3270 (commercially available from Total Petrochemicals).

The core layer preferably has a thickness in the range of about 5 μm to about 50 μm, or about 5 μm to 40 μm, and more preferably 5 μm to 25 μm, or 5 to 10 μm.

In a preferred embodiment, the core layer comprises a nucleating agent. An exemplary nucleating agent for use in a polypropylene core layer can be one that induces crystallization at a temperature near the melting point of polypropylene but by itself is solid at such a temperature. In other words, a good nucleating agent may be an organic material that has a crystallization temperature above that of polypropylene and is compatible with polypropylene at melting conditions.

Extremely high melting point materials or ground inorganic materials may be used as nucleating agents in the present disclosure. The use of organic materials may be advantageous under extrusion conditions because high melting point organic materials may be non-particulate and as such may be more readily and uniformly dispersed into the polypropylene melt. Upon cooling, the organic material will solidify throughout the polypropylene melt matrix. In this manner, a true nucleating effect can be obtained.

It is believed that the nucleating agent induces crystal growth within the core layer, thus providing more smaller crystals than that achieved without the nucleating agent. This in turn enables the core layer to be stiffer and provides improved barrier properties.

In one embodiment, a polypropylene resin may be used which includes a nucleating agent that may be non-particulate mix of carboxylic acids.

Combinations of suitable nucleating agents may also be used. Any suitable nucleating agent may be used if the nucleating agent is sufficiently well dispersed throughout the resin.

Examples of suitable commercially available nucleating agents that can be utilized in the multilayer film include: but are not limited to, 2,4-dimethylbenzilidene sorbitol, available as Millad™ 3988, disodium (1R,2R,3S,4S)-rel-bicyclo[2.2.1]heptane-2,3-dicarboxylic acid, available as Hyperform™ HPN-68L both from Milliken Chemicals; N,N′-dicyclohexyl-2,6-napthalenecarboxamide and the family of substituted 1,3,5-benzenetrisamid; and sodium 2,2′-methylene-bis-(4,6-di-tert-butylphenyl)phosphate, available as Irgastab™ NA 11 from Ciba Specialty Chemicals of Switzerland.

In another embodiment, the core layer may comprise a nucleated polypropylene. An example of a suitable commercially available nucleated polypropylene is FF035C available from Sunoco Chemicals. A propylene that has been previously nucleated may be preferred, to ensure that the nucleating agent is sufficiently well dispersed throughout the resin in the core layer.

Preferably the core layer further comprises a water vapor transmission inhibitor, such as, for example, a hydrocarbon resin (“HCR”). In one embodiment, the core layer includes a low molecular weight HCR that is compatible with polypropylene. An exemplary HCR has a suitable number average molecular weight, for example a number average molecular weight less than about 5000, preferably less than about 2000, and more preferably from about 500 to about 1000. The HCR can be natural or synthetic and can have a suitable softening point, for example from about 60° C. to about 180° C., preferably from about 80° C. to 130° C. (as determined according to ASTM-E 28). Exemplary HCRs can include petroleum resins, terpene resins, styrene resins, cyclopentadiene resins, and saturated alicyclic resins, among others.

Suitable petroleum resins can be those prepared in the presence of a catalyst or may be thermally polymerized petroleum materials. These petroleum materials can contain a mixture of resin-forming substances such as ethylindene, butadiene, isoprene, piperylene, pentylene, polystyrene, methylstyrene, vinyltoluene, indene, polycyclopentadiene, polyterpenes, polymers of hydrogenated aromatic hydrocarbons, alicyclic hydrocarbon resins, and combinations thereof.

The styrene resins can be homopolymers of styrene or copolymers of styrene with other monomers, such as, for example, alpha methylstyrene, vinyltoluene, and butadiene.

The cyclopentadiene resins can be cyclopentadiene homopolymers or cyclopentadiene copolymers. Dicyclopentadiene and substituted dicyclopentadiene resins, such as methyl-substituted dicyclopentadiene, may also be used.

Preferably, the HCR is a saturated alicyclic hydrocarbon resin. Saturated alicyclic HCRs utilized in the multilayer film may be obtained by hydrogenation of aromatic hydrocarbon resins. The aromatic resins can be obtained by polymerizing reactive unsaturated hydrocarbons containing aromatic hydrocarbons in which reactive double bonds are generally in side-chains. The saturated alicyclic resins can be obtained from the aromatic resins by hydrogenating the latter until all, or almost all, of the unsaturation has disappeared, including the double bonds in the aromatic rings. Although exemplary aromatic hydrocarbons useful in the preparation of the alicyclic resins can be compounds containing reactive double bonds in side-chains, they may also comprise aromatic hydrocarbons having reactive double bonds in condensed ring systems. Examples of such useful aromatic hydrocarbons include vinyltoluene, vinylxylene, propenylbenzene, styrene, methylstyrene, indene, methylindene, and ethylindene. Mixtures of several of these hydrocarbons may also be used. Examples of suitable commercially available alicyclic resins include Arkon™ resins by Arakawa Chemical Industries, Ltd. of Osaka, Japan.

Examples of suitable commercially available HCRs include Piccolyte™ resins from Hercules Incorporated of Wilmington, Del.; Regalrez™ and Regalite™ resins from Eastman Chemical Company of Kingsport, Tenn.; and Escorez™ and Oppera™ resins from ExxonMobil Chemical Company of Houston, Tex.

In one embodiment, the core layer may include a masterbatch of polypropylene and a HCR. It may be useful to use a masterbatch in order to ensure sufficient dispersion of the HCR throughout the core layer. An example of a suitable masterbatched HCR is, for example, PA610A, which is a masterbatch of 50% HCR and 50% polypropylene (commercially available from ExxonMobil Chemical Company). In one embodiment, the HCR is hydrogenated and has a softening point of about 140° C. and a weight average molecular weight (Mw) of 500 g/mole and is blended into a masterbatch with polypropylene.

The nucleating agent and water vapor transmission inhibitor may be substantially evenly distributed or dispersed at least laterally throughout the core layer. The nucleating agent incorporated into the core layer may be present in an amount, for example, of up to about 3000 ppm (parts-per-million) of the resin of the core layer or, for example, in an amount of about 25 ppm to about 1000 ppm, or in an amount of about 50 ppm to about 200 ppm. The water vapor transmission inhibitor may be present in an amount, for example, of up to about 30 wt %, preferably up to about 15 wt % of the core layer. In some embodiments, the water vapor transmission inhibitor is a HCR and may be present in the core layer in an amount up to about 30 wt %, preferably from about 2 wt % to about 15 wt %, more preferably from about 3 wt % to about 10 wt %, relative to the core layer.

The core layer may further comprise at least one additive in addition to the nucleating agent and the hydrocarbon resin. Examples of useful additives are opacifying agents, pigments, colorants, cavitating agents, slip agents, antioxidants, anti-fog agents, anti-static agents, fillers, and combinations thereof. Preferably, the total amount of additives in the core layer (other than the HCR and nucleating agent) may comprise up to about 20 wt % of the core layer, but in some embodiments, up to about 30 wt % of the core layer based on the total weight of the core layer.

### Tie Layer

The multilayer film of this disclosure may optionally comprise one or more tie layers. As is known to those skilled in the art, the tie layer of a multilayer film is typically used to connect two other partially or fully incompatible layers of the multilayer film structure, e.g., a core layer and a skin layer, and is typically positioned intermediate these layers. Most preferably, the multilayer film comprises at least one image-side tie layer, meaning the tie layer is located adjacent to the sealant layer upon which printing is desired to be visible. The multilayer films may also comprise a second tie layer adjacent to the opposite skin layer.

In one embodiment, there is an image-side tie layer located intermediate the core layer and the sealant layer. The image-side tie layer may be in direct contact with the surface of the core layer or, in other embodiments, another layer or layers may be intermediate the core layer and the image-side tie layer.

In another embodiment, a second tie layer is optionally present and is located intermediate the core layer and the outer skin layer.

In some preferred embodiments, the tie layer may comprise an adhesion promoting material such as a maleic anhydride modified polypropylene an example of which is ADMER™ AT1179A (commercially available from Mitsui Chemicals America, Inc.).

In some embodiments, the tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof. Most preferably, cavitating agents are present in the image-side tie layer within a range of from 1 wt % or 2 wt % or 5 wt % to 10 wt % or 20 wt % or 30 wt % by weight of the tie layer. Most preferably, colorants, pigments, and opacifying agents are substantially absent from the tie layer. Also, cavitation agents and any other opacifying agents are substantially absent from the intervening layers between the cavitated tie layer and the surface of the film upon which an image is to be visible. The Haze value for such layers should be low as described for the sealant layer above.

The thickness of the tie layer is typically in the range of about 0.50 μm to 25 μm, preferably about 0.50 μm to 12 μm, more preferably about 0.50 μm to 6 μm, and most preferably about 2.5 μm to 5 μm. However, in some thinner films, the tie layer thickness may be in the range of about 0.5 μm to 4 μm, or about 0.5 μm to 2 μm, or about 0.5 μm to 1.5 μm.

The thickness of the second tie layer may be in the range of 0.50 μm to 25 μm, preferably from about 1 μm to 12 μm, and most preferably from about 1 μm to 10 μm. Also, the thickness may be in the range of about 0.5 μm to 8 μm, or 1 μm to 6 μm, or 1 μm to 4 μm.

### Skin Layer

An outer skin layer is an optional layer and when present is provided on the opposite side of the core layer from the sealant layer. The skin layer may be contiguous to the core layer or contiguous to one or more other layers positioned intermediate the core layer and the skin layer. The skin layer may be provided to improve the film's barrier properties, processability, printability, and/or compatibility for metallization, coating, and lamination to other films or substrates.

The outer skin layer may comprise a polymer that provides a printable, imageable, or metalizable layer or that enhances processability of the film. For example, in some embodiments the outer skin layer may comprise a polymer selected from the group consisting of polyethylene (PE), PP polymer, an EP copolymer, an EPB terpolymer, a PB copolymer, an ethylene-vinyl alcohol (EVOH) polymer, and combinations thereof. Preferably, the PE polymer is high-density polyethylene (“HDPE”), such as M-6211 and HDPE M-6030 (both available from Equistar Chemical Company) or HD-6704.67 (commercially available from ExxonMobil Chemical Company); and preferably the PP polymer is an EP copolymer, such as EP-8573 (commercially available from Total Petrochemical Company).

For coating and printing functions, the outer skin layer may preferably comprise a co- or terpolymer that has been surface treated. For metallizing or barrier properties, a HDPE, PP, PB copolymer, or EVOH may be preferred. A suitable EVOH copolymer is Eval G176B (commercially available from Kuraray Company Ltd. of Japan).

The skin layer may also comprise processing aids or additives such as anti-block agents, anti-static agents, slip agents, and combinations thereof.

The thickness of the skin layer depends upon the intended function of the skin layer, but is typically in the range of about 0.50 μm to 3.5 μm, preferably from about 0.50 μm to 2 μm, and most preferably from about 0.50 μm to 1.5 μm. Also, in thinner film embodiments, the second skin layer thickness may range from about 0.50 μm to 1.0 μm or 0.50 μm to 0.75 μm.

### Additives

One or more layers of the multilayer film may further contain one or more additives. Examples of useful additives include, but are not limited to, opacifying agents, pigments, colorants, cavitating agents, slip agents, antioxidants, anti-fog agents, anti-static agents, anti-block agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required.

Examples of suitable opacifying agents, pigments, or colorants include, but are not limited to, iron oxide, carbon black, aluminum, titanium dioxide, calcium carbonate, poly terephthalate, talc, beta nucleating agents, and combinations thereof. Preferably, colorants and/or pigments are added to the core or other layer “behind” (with respect to the preferred side of the film for viewing the generated image) the film layer containing the cavitating agent, preferably the image-side tie layer. The image-side tie layer may also have colorants or pigments, but preferably they are substantially absent from the image-side tie layer.

Cavitating agents or void-initiating particles may be added to one or more layers of the multilayer film to create an opaque film. Preferably, the cavitating agents or void-initiating particles are added to the core layer and/or image-side tie layer. Generally, the cavitating or void-initiating additive includes any suitable organic or inorganic material that is incompatible with the polymer material(s) contained in the layer(s) to which the cavitating or void-initiating additive is added, at the temperature of biaxial orientation. Examples of suitable void-initiating particles include, but are not limited to, polybutylene terephthalate (“PBT”), nylon, cyclic-olefin copolymers, solid or hollow pre-formed glass spheres, metal beads or spheres, ceramic spheres, calcium carbonate, talc, chalk, or combinations thereof. The average diameter of the void-initiating particles typically ranges from about 0.1 μm to 10 μm. The particles may be of any desired shape, or preferably they are substantially spherical in shape. Preferably, the cavitating agents or void-initiating particles are present in the layer at less than 30 wt %, or less than 20 wt %, or most preferably in the range of 2 wt % to 10 wt %, based on the total weight of the layer. Alternatively, one or more layers of the multilayer film may be cavitated by beta nucleation, which includes creating beta-form crystals of polypropylene and converting at least some of the beta-crystals to alpha-form crystals thus leaving small voids remaining after the conversion.

Slip agents that may be used include, but are not limited to, higher aliphatic acid amides, higher aliphatic acid esters, waxes, silicone oils, and metal soaps. Such slip agents may be used in amounts in the range of 0.1 wt % to 2 wt % based on the total weight of the layer to which it is added. An example of a fatty acid slip additive that may be used is erucamide. In one embodiment, a conventional polydialkylsiloxane, such as silicone oil or silicone gum, additive having a viscosity of 10,000 to 2,000,000 cSt is used.

Non-migratory slip agents may be used in one or more of the outer surface layers of the multilayer films. Non-migratory means that these agents do not generally change location throughout the layers of the film in the manner of migratory slip agents. A preferred non-migratory slip agent is polymethyl methacrylate (“PMMA”). The non-migratory slip agent may have a mean particle size in the range of 0.5 μm to 15 μm, or 1 μm to 10 μm, or 1 μm to 5 μm, or 2 μm to 4 μm, depending on the layer's thickness and desired slip properties. Alternatively, the size of the particles in the non-migratory slip agent, such as PMMA, may be greater than 10% of the thickness of the surface layer containing the slip agent, or greater than 20% of the layer's thickness, or greater than 50% of the layer's thickness, or in some embodiments greater than 100% of the layer's thickness. Generally spherical, particulate non-migratory slip agents are contemplated. A commercially available example of a PMMA resins is Epostar™ which is available from Nippon Shokubai Co., Ltd. of Japan.

An example of a suitable antioxidant includes phenolic anti-oxidants, such as Irganox™ 1010, which is commercially available from Ciba-Geigy Company of Switzerland. Such an antioxidant may be used in an amount ranging from 0.1 wt % to 2 wt %, based on the total weight of the layer to which it is added.

Anti-static agents that may be used include alkali metal sulfonates, polyether-modified polydiorganosiloxanes, polyalkylphenylsiloxanes, tertiary amines, glycerol mono-stearate, blends of glycerol mono-stearate and tertiary amines, and combinations thereof. Such anti-static agents may be used in amounts in the range of about 0.05 wt % to 3 wt %, based on the total weight of the layer to which the anti-static is added. An example of a suitable anti-static agent is Armostat™ 475, commercially available from Akzo Nobel.

Useful antiblock additives include, but are not limited to, silica-based products such as inorganic particulates such as silicon dioxide, calcium carbonate, magnesium silicate, aluminum silicate, calcium phosphate, and the like. Other useful antiblock additives include polysiloxanes and non-meltable crosslinked silicone resin powder, such as Tospearl™, which is commercially available from Toshiba Silicone Co., Ltd. Anti-blocking agents may be effective in amounts up to about 30,000 ppm of the layer to which it is added.

Examples of useful fillers include but are not limited to, finely divided inorganic solid materials such as silica, fumed silica, diatomaceous earth, calcium carbonate, calcium silicate, aluminum silicate, kaolin, talc, bentonite, clay, and pulp.

Suitable moisture and gas barrier additives may include effective amounts of low-molecular weight resins, hydrocarbon resins, particularly petroleum resins, styrene resins, cyclopentadiene resins, and terpene resins. The multilayer film may also contain a hydrocarbon wax in one or more layers. The hydrocarbon wax may be either a mineral wax or a synthetic wax. Hydrocarbon waxes may include paraffin waxes and microcrystalline waxes. Typically, paraffin waxes having a broad molecular weight distribution are preferred as they generally provide better barrier properties than paraffin waxes with a narrow molecular weight distribution.

Optionally, one or more of the outer surface layers may be compounded with a wax or coated with a wax-containing coating, for lubricity, in amounts in the range of 2 wt % to 15 wt % based on the total weight of the layer.

### Film Orientation

The multilayer film may be uniaxially or biaxially oriented. Orientation in the direction of extrusion is known as machine direction (“MD”) orientation. Orientation perpendicular to the direction of extrusion is known as transverse direction (“TD”) orientation. Orientation may be accomplished by stretching or pulling a film first in the MD followed by the TD. Orientation may be sequential or simultaneous, depending upon the desired film features. Preferred orientation ratios are commonly from between about three to about six times the extruded width in the MD and between about four to about ten times the extruded width in the TD.

Blown films may be oriented by controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are BOPP tenter process and LISIM technology.

### Surface Treatment

One or both of the outer exposed surfaces of the multilayer film may be surface-treated to increase the surface energy of the film to render the film receptive to metallization, coatings, printing inks, and/or lamination. The surface treatment can be carried out according to one of the methods known in the art. Preferred methods include, but are not limited to, corona discharge, flame treatment, plasma treatment, chemical treatment, or treatment by means of a polarized flame.

In a preferred embodiment, the outermost surface of the film that is opposite the sealant layer is surface treated. Thus, in a preferred embodiment, the sealant layer is not surface treated. If there are two sealant layers, only one outer surface will generally be treated.

### Metallization

One or both of the outer exterior surfaces of the multilayer film may be metallized, but in the case of imageable films is preferably not metallized. Generally, when the films are metallized, the metallized layer is one of the outer skin and/or sealant layers. However, if no skin or sealant layer is present, the surface of a core layer may be metallized. Such layers may be metallized using conventional methods, such as vacuum deposition of a metal layer such as aluminum, copper, silver, chromium, or mixtures thereof.

Metallization is generally applied to which ever outermost surface of the film that has been treated. Metallization or coatings may be applied alone or in some cases together. When metallization and coatings are applied together, either may be applied first, followed by the other.

In some embodiments, the film may first be surface treated, for example, by flame treatment, and then be treated again in the metallization chamber, for example, by plasma treatment, immediately prior to being metallized.

### Coatings

One or more coatings, such as for barrier, printing, and/or processing, may be applied to one or both of the outer surfaces of the multilayer films. Such coatings may include acrylic polymers, such as ethylene acrylic acid (“EAA”), ethylene methyl acrylate copolymers (“EMA”), polyvinylidene chloride (“PVDC”), poly(vinyl)alcohol (“PVOH”), ethylene(vinyl)alcohol (“EVOH”), pigmented or colored versions thereof, and combinations thereof.

Before applying the coating composition, the outer surface of the film may be treated to increase its surface energy. This treatment may help to ensure that the coating layer will be strongly adhered to the outer surface of the film, and, thus, reduce the possibility of the coating peeling or being stripped from the film. This treatment can be accomplished by employing known techniques, such as flame treatment, plasma, film chlorination, treatment with oxidizing agents such as chromic acid, hot air or steam treatment, and the like, or preferably by corona discharge. After treatment of the film surface, the coating composition may then be applied thereto.

An intermediate primer coating may be applied to the multilayer film. This is particularly useful in applications where a greater coating-to-film adherence is desired than that resulting from surface treatment of the film. Before applying the primer the film may first be treated to provide increased active adhesion sites on the film's surface (thereby promoting primer adhesion). Then a continuous coating of a primer material may be applied to the surface treated film surface. Examples of useful primer materials are well known in the art and include, but are not limited to, epoxy and poly(ethylene imine) materials. The primer provides an overall adhesively active surface for thorough and secure bonding with the subsequently applied coating composition. The primer may be applied to the film by conventional solution methods, for example, by roller application.

The coating composition may be applied to the film in any conventional manner such as by an emulsion coating technique, by a solution, by gravure coating, roll coating, dipping, spraying, or the like, or may be applied by co-extrusion, and/or lamination. Any excess aqueous solution can be removed by squeeze rolls, doctor knives, and the like.

The film can be stretched in the MD, coated with the coating composition and then stretched perpendicularly in the TD. In another embodiment, the coating can be carried out after biaxial orientation is complete.

The coating composition may be applied in such an amount so that there will be deposited upon drying a smooth, evenly distributed layer. The coating may be dried by hot air, radiant heat, or by any other conventional means. Generally, the coating composition is on the order of 0.2 μm to 5 μm in thickness. Useful coatings may have coating weights in the range of 0.35 to 5.5 g of coating per square meter of film. In some embodiments, the coating weight may range from 0.5 g/m² to 1.6 g/m² for conventional PVOH coatings, 0.78 g/m² to 2.33 g/m² for conventional acrylic and low temperature seal coatings, and 1.6 g/m² to 6.2 g/m² for conventional PVDC coatings.

### INDUSTRIAL APPLICATION

The multilayer films may be useful as substantially stand-alone film webs or they may be coated, metallized, and/or laminated to other film structures. Multilayer films, according to the present disclosure, may be prepared by any suitable means. Preferably, the multilayer film is co-extruded, casted, oriented, and then prepared for its intended use such as by coating, printing, slitting, or other converting methods.

In one embodiment, the multilayer film may be formed by co-extruding the core layer, the tie layer, and the sealant layer together with any additional layers through a flat sheet extruder die at a temperature in the range of between 200° C. to 260° C., casting the film onto a cooling drum and quenching the film. The sheet is then stretched from 3 to 7 times its original size, in the machine direction (MD) orienter, followed by stretching from 5 to 10 times its original size in the transverse direction (TD) orienter. The film is then wound onto a reel. Optionally, one or both of the external surfaces may be coated and/or flame treated or corona treated before winding.

In general, the multilayer film comprises at least a core layer and a sealant layer. Additional layers may be incorporated in the multilayer film; for example, the multilayer film may comprise a one or more tie layers and/or an outer skin layer, wherein an image-side tie layer would be intermediate the core layer and the sealant layer and a second tie layer would be intermediate the core layer and the outer skin layer. The core layer generally represents from about 40 to about 90 percent of the thickness of the total film.

In one embodiment, the film is a five-layer film with an EVOH metalizable skin for improved barrier properties and an adhesion promoting tie layer between the EVOH skin and the core layer. Also, white opaque films can be made by adding a cavitating agent to the core layer.

The multilayer film may be used as a flexible packaging film to package an article or good. In some applications, the film may be formed into a pouch type of package, such as may be useful for packaging a beverage, liquid, granular, or dry-powder product.

The film may also be used as labeling or imaging film. The film may be printed by any conventional means, contemplated printing means include letterpress, offset, silk screen, electrostatic, and photographic methods. Specific printing methods contemplated include thermal dye transfer (including dye sublimation), lithographic printing, flexographic printing, gravure printing, hot stamping, valley printing, roll-leaf printing, and spanishing. Polyolefins are normally treated before printing in order to make them receptive to inks. Treating methods include casing, electronic treating, and flame treating.

The multilayered films are particularly useful as imageable films. The image may be effected by “treating” as by heat and/or physical impact either side of the film, but preferably the sealant side of the film is treated. The treatment is effectuated by passing the multilayer film through a device that imparts selective physical or thermal treatment to the image-side of the film to affect an image. Specific examples of suitable devices are lasers, thermal printing devices, block type, embossing devices, and other physical type devices, and other devices that are capable of imparting a heat or pressure generated image such as lettering, pictures, or both. Upon such treatment, the image-side tie layer preferably contracts to within the range of from 0.5% or 1% or 2% or 5% to 6% or 10% or 15% of its original thickness (prior to treatment) upon collapse of the voids created by the cavitating agent. The sealant side of the multilayered film may be coated as described to allow further ink printing, and/or the second skin may be coated and/or surface treated as by corona, plasma, etc. But preferably, inks are substantially absent from the sealant side of the film.

For some applications, it may be desirable to laminate the multilayer films to other polymeric film or paper products for purposes such as package decor including printing and metallizing.

In one embodiment, a method of preparing a multilayer film may comprise the steps of co-extruding at least: a core layer and a sealant layer, wherein the sealant layer comprises a FPC and a SPC. The method may further comprise the step of orienting the co-extruded, multilayer film in at least one direction. The method may further comprise additionally co-extruding one or more tie layers and/or an outer skin layer.

The method may further comprise the steps of enclosing a product or article within at least a portion of the co-extruded film, engaging a first portion of the skin layer with a second portion of the skin layer at a seal area, and applying pressure and heat at the seal area, optionally for a determined duration of time, to cause the first portion to engage with the second portion to create at least one of a fin seal, a lap seal, and a crimp seal in the seal area.

Heat seals useful in packaging are commonly lap and fin seals, as crimp or flat seals. Most frequently, vertical form fill and seal (“VFFS”) and/or horizontal form fill and seal (“HFFS”) useful in snack packaging will employ a flat fin seal and two crimp seals. For extended shelf life, a hermetic seal is desirable. A hermetic seal is generally one that does not permit the passage of a gas.

In some embodiments, the film comprises a sealant layer containing a SPC and a tie layer wherein the tie layer is substantially free of SPC. In another embodiment, the film comprises a sealant layer containing a SPC and the core layer is substantially free of SPC. In a further embodiment, the film comprises a sealant layer containing a SPC and both the tie layer and the core layer are substantially free of SPC.

While the illustrative embodiments have been described with particularity, it will be understood that various other modifications will be apparent to, and can be readily made by, those skilled in the art without departing from the spirit and scope of the invention. To the extent that this description is specific, it is solely for the purposes of illustrating certain embodiments of the invention and should not be taken as limiting the present inventive concepts to these specific embodiments. Accordingly, it is not intended that the scope of the claims appended hereto be limited to the examples and descriptions set forth herein but rather that the claims should be construed as encompassing all the features of patentable novelty which reside in the present disclosure, including all features which would be treated as equivalents thereof by those skilled in the art to which the disclosure pertains.

### EXAMPLES

The inventive multilayer films will now be further described with reference to the following non-limiting examples. When possible, standard ASTM tests were used to determine the multi-layer film's properties. Table 1 summarizes some of the testing procedures used.

The procedure for Differential Scanning calorimetry (“DSC”) is described as follows. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a Differential Scanning calorimeter (“DSC”) (Perkin Elmer Pyris One Thermal Analysis System) and cooled to about −50° C. to about −70° C. The sample is heated at 10° C./min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. The total energy absorbed or released by the sample during the testing procedure is the ΔH, which is expressed as Joules per gram of polymer. The melting point is recorded as the temperature of the greatest heat absorption with respect to a baseline within the range of the melting of the sample.

The melt flow rate (“MFR”) is measured according to ASTM D-1238, wherein a 2.16 kg weight at 230° C. with a 1 minute preheat on the sample to provide a steady temperature for the duration of the experiment is used. The melt index (“MI”) is measured according to ASTM D-1238, condition E, 190° C., 2.16 kg mass; expressed in g/10 min.

Techniques for determining molecular weight distribution (MWD) may be found in U.S. Pat. No. 4,540,753, incorporated herein by reference.

Percent crystallinity was derived from the thermal output measured on the DSC procedure described above. The thermal output for the highest order of polypropylene is estimated at 189 J/g (i.e., 100% crystallinity is equal to 189 J/g).

Seal strength may be determined using sealing devices such as LAKO™ Heat Sealer (MODEL SL-10) and HAYSSEN™ Heat Sealer (Model Ultimate II). Also, the seal strength of flexible barrier materials may be determined according to the ASTM F 88-00.

The thickness of the film and the thickness of the film's layers were measured using an optical gauge Model #283-20 available from Beta LaserMike, Dayton, Ohio.

Minimum seal temperature (“MST”) is a measure of the sealing property of a film and is the temperature at which a heat seal may support a given force and is determined as follows: heat seals are formed using one of the above heat sealers at temperatures that are raised incrementally. The minimum seal temperature is reached when one temperature yields a seal value of less than a specified g/cm peel force and the next temperature yields a seal value of greater than or equal to the specified g/cm peel force. The specified peel force of the LAKO™ Heat Sealer and HAYSSN™ Heat Sealer is 80 g/cm.

A LAKO™ Heat Sealer (Model SL-10) (commercially available from Lako Tool & Manufacturing, Inc.) may be used to form a seal and evaluate its seal strength. The LAKO™ Heat Sealer is an automated film testing device that is capable of forming a film seal, determining the seal strength, and generating a seal profile from film samples. The operating range is from ambient to 199° C., sealing pressure of 0.04 MPa to 2.69 MPa, and a dwell time of 0.2 seconds to 20 seconds.

The seal strength of a seal formed using the Hayssen™ Ultima II vertical form, fill and seal (“VFFS”) machine (commercially available from Hayssen Packaging Technologies), may be determined as follows: a film or lamination is placed on the machine. The lap and/or fin seal temperature is set above the MST of the film or lamination. In the examples, the multilayer films were extrusion laminated on the outside to Bicor™ LCX (an OPP film commercially available from ExxonMobil Chemical Company). A total of six to nine empty bags measuring approximately 35.6 cm by 13.3 cm are produced at the rate of 55 bags/min. Two bags are randomly selected and seal strengths are measured on a Suter tester. Preferred seal strength range is greater than 80 g/cm. The crimp temperature is increased in increments of approximately 5.5° C., and the test is repeated according to the steps above until the film or lamination is visually, thermally distorted. The seal range is reported as upper crimp distortion temperature minus the crimp MST. The method described above is repeated to determine the seal strength of the lap and/or fin seal.

Hot tack performance may be determined using a Hayssen™ Ultima II VFFS machine. A roll of film or lamination is placed on the VFFS machine. The crimp temperature is set at or above the MST of the film or lamination. The lap and/or fin seal temperature is set above the MST of the film or lamination. In the examples, the multilayer films were extrusion laminated on the outside to LCX. A total of six to nine empty bags measuring approximately 35.6 cm by 13.3 cm are produced at the rate of 55 bags/min. Three bags are randomly selected and filled with approximately 16 ounces of red kidney beans. A horizontal crimp jaw design was used. The bags are then examined for seal creep (e.g., loosening or release of seal width). Preferred seal creep is less than 0.16 cm for all crimp seals and lap and/or fin seals on the bag. The crimp temperature is increased at increments of approximately 5.5° C. until the film or lamination is visually thermally distorted. Seal and hot tack ranges are reported as upper seal distortion temperature minus the seal MST. Seal penetration was measured in 32nds of an inch, therefore a 1 means that 1/32nds of an inch of creep was measured and a 2 indicates that 2/32nds of an inch of creep was measured, etc. Acceptable creep was defined as less than or equal to 2/32nds of an inch. NC indicates that no creep was measured, and CF indicates that there was complete seal failure.

Water vapor transmission rate (“WVTR”) is the steady state rate at which water vapor permeates through a film at specified conditions of temperature and relative humidity. The WVTR was measured according to ASTM F-1249 at 100° F. (37.8° C.) and 90% relative humidity with values expressed in g/m²/24-hr.

TABLE 1
Test Methods

| Parameter | Test |
|---|---|
| Density | ASTM D-1505 |
| Flexural Modulus | ASTM D-790 |
| Elongation at Break | ASTM D-638 |
| Heat of Fusion | ASTM E 794-85 |

A listing of the various components used in the multi-layer films of the examples is in Table 2.

TABLE 2
Various Components in the Multi-Layer Films

| | | Commercial |
|---|---|---|
| Material | Brief Description | Source |
| PP-4712 | Polypropylene homopolymer having | ExxonMobil |
| | a density of 0.900 g/cm³ and an MFR | Chemical |
| | (2.16 kg @ 230° C., ASTM D-1238) | Company |
| | of 2.8 g/10 min. | |
| EP-8573 | Propylene-ethylene random copolymer | Total |
| | having a density of 0.895 g/cm³ | Petrochemicals |
| | (ASTM D-1505) and an MFR (2.16 kg | |
| | @ 230° C., ASTM D-1238) of | |
| | 6.8 g/10 min. | |
| JPC XPM7794 | Ethylene-butene-propylene terpolymer. | Japan |
| | | Polypropylene |
| | | Company |
| JPC XPM7510 | Ethylene-butene-propylene terpolymer. | Japan |
| | | Polypropylene |
| | | Company |
| Vistamaxx ™ | Propylene-ethylene elastomer having | ExxonMobil |
| 3000 | a density of 0.871 g/cm³, an MFR | Chemical |
| | (2.16 kg @ 230° C., ASTM D-1238) | Company |
| | of 8.0 g/10 min, an Mw/Mn of 2, a | |
| | melting point of 61.8° C. and a | |
| | propylene content of 84.4 mol %. | |
| Vistamaxx ™ | Propylene-ethylene elastomer. | ExxonMobil |
| 3980 | | Chemical |
| | | Company |
| Vistamaxx ™ | Propylene-ethylene elastomer having | ExxonMobil |
| 6100 | a density of 0.855 g/cm³, an MFR | Chemical |
| | (2.16 kg @ 230° C., ASTM D-1238) | Company |
| | of 3.0 g/10 min, an Mw/Mn of 2, a | |
| | melting point of 46.3° C. and a | |
| | propylene content of 77.8 mol %. | |
| FF035C1 | PP + Nucleator. | Sunoco |
| FF035C2 | PP without Nucleator. | Sunoco |
| PA-609 | PP/HCR masterbatch. | ExxonMobil |
| | | Chemical Co. |
| Millad 8H4i-10 | Nucleating agent concentrate. | Milliken |
| | | Chemical Co. |
| Bicor ™ LCX | OPP Film. | ExxonMobil |
| | | Oil Corp. |

Various co-extruded biaxially oriented multilayer films were made and tested. The multilayer films were melting co-extruded, quenched on a casting drum, and subsequently reheated in the machine direction orienter to about 85° C. to about 105° C. The film was then stretched in the MD at 4.3 times and further annealed, in the annealing section of the machine direction orienter. The MD stretched film was subjected to further transverse direction orientation via conventional tenter frame at nine times in the TD. The typical transverse direction preheat temperature is about 155° C. to about 180° C., stretching temperature is about 145° C. to about 165° C., and standard annealing temperature is about 165° C. to 170° C. The metallizable skin layer was then treated by a conventional flame treatment method and then metallized by vacuum deposition of aluminum.

### Examples 1-3

In Examples 1-3, the multilayer films had a sealant layer, a core layer, and an outer skin layer. The outer skin layer was on the water-bath side. The sealant layer was on the cast-roll side. An example of a representative film structure is shown in Table 3. The films were flame treated on the water bath side. The multilayer films were rolled and then the rolls were slit to 15″ width on 3″ core, out to out, for lamination and packaging test. The multilayer films were tested for various properties including, haze, Lako seal, VFFS seal, hot tack, and tensile.

TABLE 3
Representative Film Structure of Films in Examples 1-3

| | | | Thickness | | |
|---|---|---|---|---|---|
| | Layer | Structure/Resin | μm | Gauge | % |
| Film | OUT | Flame Treatment | | | |
| | Skin | EPB Terpolymer Skin | 0.76 | 3 | 4.3 |
| | Tie | Polypropylene | 15.7 | 62 | 88.6 |
| | Core | Polypropylene | | | |
| | Tie | Polypropylene | | | |
| | Sealant Skin | Skin Blend | 1.3 | 5 | 7.1 |
| | IN | | | | |

### Example 1

In Example 1, the sealant layer comprised a blend of an EPB terpolymer and varying amounts of different grades of Vistamaxx™ propylene-based elastomer available from ExxonMobil Chemical Co. Table 4 shows the film structures of the sample films in Example 1. The films were tested for a variety of properties, with the results shown in Table A. Table 5 shows the results of a VFFS evaluation of the sample films at varying temperatures.

TABLE 4
Example 1 Film Structures

| | Outer Skin | Core | Sealant layer | | | |
|---|---|---|---|---|---|---|
| | Layer | Layer | JPC | VMX | VMX | |
| | JPC 7510 | PP-4712 | 7794 | 6100 | 3000 | VMX 3980 |
| Film A | 100% | 100% | 100% | 0 | 0 | 0 |
| Film B | 100% | 100% | 85% | 15% | 0 | 0 |
| Film C | 100% | 100% | 70% | 30% | 0 | 0 |
| Film D | 100% | 100% | 85% | 0 | 15% | 0 |
| Film E | 100% | 100% | 70% | 0 | 30% | 0 |
| Film F | 100% | 100% | 70% | 0 | 0 | 30% |

TABLE 5
VFFS Evaluation of Example 1 Films*

| | | Seal Temp | | | | | | | |
|---|---|---|---|---|---|---|---|---|---|
| | | 71° C. | 77° C. | 82° C. | 88° C. | 99° C. | 110° C. | 132° C. | 154° C. |
| Film A | Seal Strength (g/in) | | | 455 | 685 | 955 | 845 | 935 | 1040 |
| | Hot Tack | | | 1, 2, 5 | 1, 1, 1 | 1, 1, 1 | 1, 1, 1 | NC | 1, 1, 1 |
| Film B | Seal Strength (g/in) | | 235 | 435 | 700 | 870 | 825 | 895 | 1000 |
| | Hot Tack | | | 2, 2, 2 | 1, 1, NC | 1, NC, NC | 1, 1, NC | 1, NC, NC | 1, 1, NC |
| Film C | Seal Strength (g/in) | 75 | 330 | 525 | 590 | 955 | 995 | 955 | 940 |
| | Hot Tack | | 1, 1, 2 | 1, 1, 1 | NC | NC | NC | NC | 1, 1, NC |
| Film D | Seal Strength (g/in) | | 85 | 300 | 760 | 755 | 825 | 985 | 945 |
| | Hot Tack | | | 1, 1, 6 | 1, 1, 1 | 1, NC, NC | NC | NC | 1, 1, NC |
| Film E | Seal Strength (g/in) | | 450 | 390 | 645 | 1025 | 1000 | 815 | 865 |
| | Hot Tack | | 1, 2, 6 | 1, 1, NC | 2, 1, NC | 1, NC, NC | NC | NC | 1, NC, NC |

*The hot tack is an observation of three bags at the seal area. The number indicates 1/32″ of seal opening, with NC or 1 as pass and any number greater than 2 as failure.

As shown in the VFFS testing, adding Vistamaxx™ 6100 to the JPC 7794 helped improve the MST and the hot tack slightly (See Table 5, Films B and C). When 30 wt % of Vistamaxx™ 3000 was blended with JPC-7794 in the sealant skin, this helped to improve the hot tack of the film, and lowered the MST by about 5° C. to 77° C. on the VFFS packaging test (see Table 5, Film E).

As seen in TABLE A, adding Vistamaxx™ into the sealant layer had little impact on the multilayer film's tensile properties. At seal temperatures below 260° F. (127° C.), the Vistamaxx™ in the sealant skin helped to improve the seal strength as compared to the film with only JPC 7794 in the sealant skin.

### Example 2

In Example 2, the sealant layer comprised a blend of an EPB terpolymer and varying amounts of different grades of Vistamaxx™ propylene-based elastomer. The EPB terpolymer used in Example 2 (JPC 7510) has a higher melting point than the EPB terpolymer used in Example 1 (JPC 7794). Table 6 shows the film structures of the sample films in Example 2. The films were tested for a variety of properties, with the results shown in Table B. Table 7 shows the results of a VFFS evaluation of the sample films at varying temperatures.

TABLE 6
Example 2 Film Structures

| | Outer Skin | Core | Sealant layer | | | |
|---|---|---|---|---|---|---|
| | Layer | Layer | JPC | VMX | VMX | |
| | JPC 7510 | PP-4712 | 7510 | 6100 | 3000 | VMX 3980 |
| Film G | 100% | 100% | 100% | 0 | 0 | 0 |
| Film H | 100% | 100% | 85% | 15% | 0 | 0 |
| Film I | 100% | 100% | 70% | 30% | 0 | 0 |
| Film J | 100% | 100% | 85% | 0 | 15% | 0 |
| Film K | 100% | 100% | 70% | 0 | 30% | 0 |
| Film L | 100% | 100% | 70% | 0 | 0 | 30% |

TABLE 7
VFFS Evaluation of Example 2 Films

| | | Seal Temp | | | | |
|---|---|---|---|---|---|---|
| | | 110° C. | 116° C. | 121° C. | 132° C. | 154° C. |
| Film | Seal | | 330 | 845 | 820 | 885 |
| G | Strength | | | | | |
| | (g/in) | | | | | |
| | Hot Tack | | | 1, 1, NC | 1, NC, NC | 1, 1, NC |
| Film | Seal | | 470 | 895 | 970 | 865 |
| H | Strength | | | | | |
| | (g/in) | | | | | |
| | Hot Tack | | 1, 3, 3 | 1, 1, 1 | NC | 1, 1, NC |
| Film | Seal | 265 | | 880 | 1030 | 1080 |
| I | Strength | | | | | |
| | (g/in) | | | | | |
| | Hot Tack | 1, 1, 2 | | NC | NC | 1, 1, 2 |
| Film | Seal | 60 | 665 | | 945 | 1095 |
| K | Strength | | | | | |
| | (g/in) | | | | | |
| | Hot Tack | | 1, 1, 2 | | NC | 1, 1, NC |
| Film | Seal | 240 | 495 | 985 | 1030 | 990 |
| L | Strength | | | | | |
| | (g/in) | | | | | |
| | Hot Tack | | 1, 1, 1 | 1, NC, NC | 1, NC, NC | 1, 1, NC |

* The hot tack is an observation of three bags at the seal area. The number indicates 1/32″ of seal opening, with NC or 1 as pass and any number greater than 2 as failure.

As seen in Table 7, adding Vistamaxx™ into the sealant skin containing JPC 7510 helped to improve hot tack. Adding 30% Vistamaxx™ into the sealant layer containing JPC 7510, helped to reduce MST by 20° F. (6.7° C.), but the MST was not as good as that seen in the Films of Example 1 containing JPC 7794.

As seen in Example 2, when JPP-7510 was blended with Vistamaxx™ in the sealant skin, the Vistamaxx™ helped to improve the seal strength and hot tack of the multilayer film, as well as lowering the MST. However, even with the improvements gained by blending Vistamaxx™ with JPP-7510 the multilayer films of Example 2 did not perform as well as the films in Example 1 which contained an EPB terpolymer with a very low sealing temperature (JPC 7794).

### Example 3

In Example 3, the sealant layer comprised a blend of an EP copolymer and varying amounts of different grades of Vistamaxx™ propylene-based elastomer. Table 8 shows the film structures of the sample films in Example 8. The films were tested for a variety of properties, with the results shown in Table C. Table 9 shows the results of a VFFS evaluation of the sample films at varying temperatures.

TABLE 8
Example 3 Film Structures

| | Outer Skin | Core | Sealant layer | | | |
|---|---|---|---|---|---|---|
| | Layer | Layer | | VMX | VMX | VMX |
| | JPC 7510 | PP-4712 | EP-8573 | 6100 | 3000 | 3980 |
| Film M | 100% | 100% | 100% | 0 | 0 | 0 |
| Film N | 100% | 100% | 85% | 15% | 0 | 0 |
| Film O | 100% | 100% | 70% | 30% | 0 | 0 |
| Film P | 100% | 100% | 85% | 0 | 15% | 0 |
| Film Q | 100% | 100% | 70% | 0 | 30% | 0 |
| Film R | 100% | 100% | 70% | 0 | 0 | 30% |

TABLE 9
VFFS Evaluation of Example 3 Films

| | | Seal Temp | | | | | | |
|---|---|---|---|---|---|---|---|---|
| | | 116° C. | 121° C. | 127° C. | 132° C. | 138° C. | 154° C. | 154° C. |
| Film M | Seal Strength (g/in) | | | 180 | 695 | 670 | | 1020 |
| | Hot Tack | | | CF | 3, 3, 4 | 2, 2, 1 | | 2, 2, 3 |
| Film N | Seal Strength (g/in) | | 410 | 820 | 1045 | | 1150 | |
| | Hot Tack | | 1, 3, 3 | 1, NC, NC | NC | | 1, 1, 1 | |
| Film O | Seal Strength (g/in) | 310 | 520 | | 900 | | 1065 | |
| | Hot Tack | 2, 3, 4 | 1, 1, 1 | | NC | | 1, NC, NC | |
| Film P | Seal Strength (g/in) | | 575 | | 835 | | 1015 | |
| | Hot Tack | | 1, 1, 2 | | NC | | 1, NC, NC | |
| Film Q | Seal Strength (g/in) | 70 | 670 | | 1060 | | 1065 | |
| | Hot Tack | | 1, 1, 2 | | NC | | 1, 1, NC | |

* The hot tack is an observation of three bags at the seal area. The number indicates 1/32″ of seal opening, with NC or 1 as pass and any number greater than 2 as failure.

As seen in Example 3, adding Vistamaxx™ propylene-based elastomer as a second polymer component helped to improve the seal strength as well as hot tack for films containing EP-copolymer (EP-8573) in the sealant skin as well as lowering the MST to around 240° F. (116° C.) on VFFS packaging test. This improvement enabled the films in Example 3 which contained EP-copolymer in the sealant skin blend to have a similar seal performance as those films containing the JPP-7510 EPB terpolymer in the sealant skin blend (Example 2). By blending the EP-copolymer with Vistamaxx™ it performed like an EPB terpolymer.

In Examples 1, 2, and 3 there was little to no impact observed on the processability (i.e., co-extrusion and biaxial orientation) of the multilayer film when adding Vistamaxx™, which has a low melting temperature, into the film's sealant layer. There was no MDO or surface imperfections observed, even when 30% Vistamaxx™ was used.

Vistamaxx™ 6100, Vistamaxx™ 3000, and Vistamaxx™ 3980 were found to be compatible when blended with EP copolymers and EPB terpolymers in the sealant skin. Even when up to 30% of Vistamaxx™ was used there was no negative effect on the film's total haze level or on the film's tensile properties.

When Vistamaxx™ was blended in the sealant skin with EPB terpolymers which originally had good seal performance, the Vistamaxx™ propylene-based elastomer improved the seal performance (i.e., hot tack and seal strength) further by about 20% to 30% at low temperature seal range.

At heat seal temperatures below 260° F. (127° C.), Vistamaxx™ helped to improve seal strength when blended with JPC-7794. In blends of JPC-7510 with Vistamaxx™, the addition of Vistamaxx™ helped to improve seal strength at up to 280° F. (138° C.). There was little or no impact on lowering the films MST. When Vistamaxx™ was adding to sealant skins containing EP-8573, both seal strength and hot tack properties were improved. In blends with either JPC 7510 or EP-8573, Vistamaxx™ improved seal strength at up to 280° F. (138° C.).

For EPB terpolymers, which already have generally good hot tack, the addition of Vistamaxx™ showed no impact on hot tack. However, when blended with EP-8573, which generally has poor hot tack, adding Vistamaxx™ improved hot tack to the almost to the level achieved with an EPB terpolymer.

### Examples 4-7

A representative film structure of the multilayer films in Examples 4-7 is shown in Table 10. The outer skin layer was on the water-bath side. The sealant layer was on the cast-roll side. The films were flame treated on the water bath side. The multilayer films were tested for various properties including, haze, Lako seal, hot tack, and tensile.

TABLE 10
Representative Film Structure of Films in Examples 4-6

| | | | Thickness | | |
|---|---|---|---|---|---|
| | Layer | Structure/Resin | μm | Gauge | % |
| Film | OUT | Flame Treatment | | | |
| | Skin | EPB Terpolymer Skin | 0.76 | 3 | 3.75 |
| | Tie | Polypropylene | 18.3 | 72 | 90 |
| | Core | Polypropylene | | | |
| | Tie | Polypropylene | | | |
| | Sealant Skin | Skin Blend | 1.27 | 5 | 6.5 |
| | IN | | | | |

In Examples 4-7, other polymers, besides just Vistamaxx™ propylene-based elastomer, were used as the SPC in the sealant layer. The FPC was selected from low crystallinity EPB terpolymers, EP copolymers, PB copolymers, and C4 homopolymers, all of which had a ΔH value of less than 75 J/g. A comparison of the different FPCs is in Table 11. A comparison of the different SPCs in Table 12. A comparison of the ΔH of the different FPCs and SPCs is shown in Table 13; DSC analysis of the polymers evaluated during this trial showed that the polymers had a ΔH less than 75 J/g.

TABLE 11
Comparison of First Polymer Components

| | | | | Adsyl | Basell |
|---|---|---|---|---|---|
| | JPP 7794 | JPP 7510 | Total 8573 | 3C30FHP | PB0300M |
| m.p. (° C.) | 124 | 137 | 132 | 141 | 126 |
| MST | 95 | 105 | 125 | 11 | |
| ΔH (J/g) | 55 | 69 | 65 | 72 | 70 |

TABLE 12
Comparison of Second Polymer Components

| | VMX | VMX | VMX | Exact | Escorene |
|---|---|---|---|---|---|
| | 3980 | 6100 | 3000 | 5181 | 720.92 (EVA) |
| m.p. (° C.) | 76 | 44 | 73 | 73 | 86 |
| ΔH (J/g) | 16 | 11 | 40 | | 42 |
| Tg (° C.) | −20 | −28 | −18 | | |
| MWD | 2 | 2 | 2 | | |
| MI | | | | 1.1 | 1.6 |
| MFR | 8 | 3 | 8 | | |

TABLE 13
DSC Analysis of FPCs and SPCs

| | 1^{st} Heat | | | 2^{nd} Heat | |
|---|---|---|---|---|---|
| Resin | (° C.) | ΔH (J/g) | Tc (° C.) | (° C.) | ΔH (J/g) |
| 7794 | 124.2 | 55.4 | 86.9 | 125.8 | 52.4 |
| 7510 | 136.6 | 69.4 | 96 | 133.6 | 70.8 |
| 8573 | 131.6 | 64.6 | 92.5 | 133.5 | 68.7 |
| 3C30FHP | 141.1 | 71.8 | 98.3 | 139.8 | 80.1 |
| VMX3980 | 76.2 | 15.8 | | 76.4 | 22.6 |
| LD720.92 | 86 | 42 | 67.5 | 85.4 | 46.4 |
| PB0300M | 126.4 | 70.1 | 70.5 | 116.7 | 39.8 |

### Example 4

In Example 4, the sealant layer comprised a blend of an Adsyl and varying amounts of either Vistamaxx™ propylene-based elastomer, E-5181, or LD-720.92. Table 14 shows the film structures of the sample films in Example 4. The films were tested for a variety of properties, with the results shown in Table D.

TABLE 14
Example 4 Film Structures

| | Outer | | | | | |
|---|---|---|---|---|---|---|
| | Skin | Core | Sealant layer | | | |
| | Layer | Layer | Adsyl3 | VMX | | LD- |
| | JPC 7510 | PP-4712 | C30 FHP | 3980 | E-5181 | 720.92 |
| Film AA | 100% | 100% | 100% | 0% | 0% | 0% |
| Film BB | 100% | 100% | 90% | 10% | 0% | 0% |
| Film CC | 100% | 100% | 80% | 20% | 0% | 0% |
| Film DD | 100% | 100% | 90% | 0% | 10% | 0% |
| Film EE | 100% | 100% | 80% | 0% | 20% | 0% |
| Film FF | 100% | 100% | 90% | 0% | 0% | 10% |
| Film GG | 100% | 100% | 80% | 0% | 0% | 20% |

In Example 4, where the FPC was a C3/C4 copolymer (Adsyl 3C30) the seal performance was improved by adding either Vistamaxx™ 3980, a C2 elastomer (Exact Plastomer 5181, available from ExxonMobil Chemical Co.), or an EVA (LD-720.92). Additionally, the MST was lowered by 5° F. (−15° C.) to 15° F. (9.4° C.). The seal strength at low temperature range was also improved. All of the samples showed improved Lako seal strength; however, in the low temperature sealing range, Vistamaxx™ 3980 seemed to be the most effective in improving the seal strength. At higher seal temperatures, both Exact 5181 and LD 720.92 (EVA) were more effective in improving the film's seal strength. Vistamaxx™ 3980 was the most effective in improving the low temperature hot tack strength. At higher seal temperatures, the improvement in hot tack was only from 10% to 20%.

### Example 5

In Example 5, the sealant layer comprised a blend of PB030M and varying amounts of either Vistamaxx™, Exact 5181, or LD-720.92. Table 15 shows the film structures of the sample films in Example 5. The films were tested for a variety of properties, with the results shown in Table E.

TABLE 15
Example 5 Film Structures

| | Outer | | | | | |
|---|---|---|---|---|---|---|
| | Skin | Core | Sealant layer | | | |
| | Layer | Layer | | VMX | | LD- |
| Film | JPC 7510 | PP-4712 | PM0300M | 3980 | E-5181 | 720.92 |
| HH | 100% | 100% | 100% | 0% | 0% | 0% |
| II | 100% | 100% | 90% | 10% | 0% | 0% |
| JJ | 100% | 100% | 80% | 20% | 0% | 0% |
| KK | 100% | 100% | 90% | 0% | 10% | 0% |
| LL | 100% | 100% | 80% | 0% | 20% | 0% |
| MM | 100% | 100% | 90% | 0% | 0% | 10% |
| NN | 100% | 100% | 80% | 0% | 0% | 20% |

In Example 5, where the FPC was a C4 (polybutylene) (Basell PB0300M), both Exact 5181 and Vistamaxx™ 3980 improved the seal performance; however, the addition of LD-720.92 did not improve the seal performance. All of the samples with PB0300M had a slightly higher haze. Furthermore, when EVA was added into PB0300M skin, the haze level was even higher, possibly indicating a resin blend incompatibility. In Example 5 Vistamaxx™ 3980 was the most effective SPC in improving seal strength. When Exact 5181 and LD-720.92 EVA were blended with PB0300M the seal strength was reduced, possibly indicating an incompatibility of the sealant layer components. Furthermore, the hot tack strength of the films in Example 5 was negatively effected by the addition of the SPCs to PB0300M in the sealant layer. This could also possibly be due to sealant skin resin blend incompatibility.

### Example 6

In Example 6, the sealant layer was a blend of JPC 7510 and varying amounts of either Vistamaxx™ propylene-based elastomers, Exact 5181 plastomer, or LD-720.92. Table 16 shows the film structures of the sample films in Example 6. The films were tested for a variety of properties, with the results shown in Table 17.

TABLE 16
Example 6 Film Structures

| | Outer | | | | | |
|---|---|---|---|---|---|---|
| | Skin | Core | Sealant layer | | | |
| | Layer | Layer | | VMX | | LD- |
| Film | JPC 7510 | PP-4712 | JPC 7510 | 3980 | E-5181 | 720.92 |
| OO | 100% | 100% | 100% | 0% | 0% | 0% |
| PP | 100% | 100% | 70% | 0% | 30% | 0% |
| QQ | 100% | 100% | 70% | 0% | 0% | 30% |
| RR | 100% | 100% | 70% | 30% | 0% | 0% |

TABLE 17
Properties of Example 6 Films

| | | | Lako Seals | | | | | Lako Hot Tack | | | | |
|---|---|---|---|---|---|---|---|---|---|---|---|---|
| | | Total | 60 psi, 0.75 sec dwell, 20 sec | | | | | 60 psi, 0.75 sec dwell, 0 sec | | | | |
| | | Film | cooling, vertical jaw (° F.) | | | | | cooling, vertical jaw (° F.) | | | | |
| | Haze | Gauge | g/in | | | | | g/in | | | | |
| Film | % | mil | 200 | 220 | 240 | 260 | 280 | 200 | 220 | 240 | 260 | 280 |
| OO | 1 | 0.70 | 45 | 56 | 431 | 360 | 396 | | 52 | 293 | 362 | 382 |
| PP | 6.8 | 0.70 | | 138 | 425 | 547 | 422 | 28 | 108 | 227 | 282 | 296 |
| QQ | 9.6 | 0.70 | 52 | 329 | 478 | 702 | 571 | | 106 | 180 | 301 | 216 |
| RR | 0.9 | 0.70 | 333 | 401 | 412 | 416 | 789 | | 182 | 380 | 360 | 258 |

### Example 7

In Example 7, the sealant layer comprised a blend of JPC 7794 and varying amounts of either Vistamaxx™, Exact 5181, or LD-720.92. Table 18 shows the film structures of the films in Example 6. The films were tested for a variety of properties, with the results shown in Table 19.

TABLE 18
Example 7 Film Structures

| | Outer Skin | Core | | | |
|---|---|---|---|---|---|
| | Layer | Layer | Sealant layer | | |
| | JPC 7510 | PP-4712 | 7510 | VMX 3000 | VMX 3980 |
| Film SS | 100% | 100% | 100% | 0% | 0% |
| Film TT | 100% | 100% | 85% | 15 | 0% |
| Film UU | 100% | 100% | 70% | 0% | 30% |

TABLE 19
Properties of Example 7 Films

| | | | Lako Seals | | | | | Lako Hot Tack | | | | |
|---|---|---|---|---|---|---|---|---|---|---|---|---|
| | | Total | 60 psi, 0.75 sec dwell, 20 sec | | | | | 60 psi, 0.75 sec dwell, 0 sec | | | | |
| | | Film | cooling, vertical jaw (° F.) | | | | | cooling, vertical jaw (° F.) | | | | |
| | Haze | Gauge | g/in | | | | | g/in | | | | |
| Film | % | mil | 200 | 220 | 240 | 260 | 280 | 200 | 220 | 240 | 260 | 280 |
| SS | 1.7 | 0.70 | 333 | 401 | 412 | 416 | 789 | 156 | 271 | 428 | 387 | 270 |
| TT | 1.3 | 0.66 | 440 | 940 | 1160 | 1350 | 1200 | 220 | 400 | 405 | 400 | 425 |
| UU | 1.3 | 0.70 | 361 | 486 | 377 | 679 | 969 | 258 | 435 | 328 | 310 | 264 |

In Examples 4-7, various FPCs and SPCs were blended in the sealant layer. Even with the addition of the softer SPC, all of the sample films showed similar tensile properties. However, as compared to low ΔH sealant skins in Examples 1-3 and 6-7, both Adsyl 3C30FHP and PB0300M (Examples 4 and 5) with higher ΔH values showed less seal performance improvement when blended with a SPC as compared to JPP-7794, 7510, and EP-8573 resins.

### Examples 8-9

An example of a representative film structure of the films in Examples 8-9 is shown in Table 20. The outer skin layer was on the water-bath side. The sealant layer was on the cast-roll side. An example of a representative film structure is shown in Table 20. The films were made with a target film gauge of 0.7 mm, and were flame treated on the water bath side. The multilayer films were tested for various properties including, haze, Lako seal, hot tack, tensile, and WVTR.

TABLE 20
Representative Film Structure of Films in Examples 8-9

| | | | Thickness | | |
|---|---|---|---|---|---|
| | Layer | Structure/Resin | μm | Gauge | % |
| Film | OUT | Flame Treatment | | | |
| | Skin | EPB Terpolymer Skin | 0.76 | 3 | 4.3 |
| | Tie | Core Polymer + Additives | 15.7 | 62 | 88.6 |
| | Core | Core Polymer + Additives | | | |
| | Tie | Core Polymer + Additives | | | |
| | Sealant Skin | Skin Blend | 1.3 | 5 | 7.1 |
| | IN | | | | |

### Example 8

In Example 8, the core layer contained a core polymer and varying amounts of HCR and nucleators. The sealant layer comprised a blend of JPC 7794 and varying amounts of Vistamaxx™ 3980. Table 21 shows the film structures of the sample films in Example 8. The films were tested for a variety of properties, with the results shown in Table F.

TABLE 21
Example 8 Film Structures

| | Outer | | | | | |
|---|---|---|---|---|---|---|
| | Skin | Core Layer | | | Sealant layer | |
| | Layer | PP- | | | | VMX |
| | JPC 7510 | 4712 | PA-609 | 8HFi-10 | JPC 7794 | 3980 |
| Film 8A | 100% | 100% | 0% | 0% | 100% | 0% |
| Film 8B | 100% | 100% | 0% | 0% | 70% | 30% |
| Film 8C | 100% | 100% | 0% | 0% | 85% | 15% |
| Film 8D | 100% | 85% | 15% | 0% | 85% | 15% |
| Film 8E | 100% | 85% | 15% | 0% | 70% | 30% |
| Film 8F | 100% | 82% | 15% | 3% | 70% | 30% |
| Film 8G | 100% | 82% | 15% | 3% | 85% | 15% |
| Film 8H | 100% | 82% | 15% | 3% | 100% | 0% |
| Film 8I | 100% | 97% | 0% | 3% | 100% | 0% |

Film 8I, which contained only nucleating agent in the core, required higher mechanical stretch force for the MD stretch as the film was more rigid, as compared to Films 8F-8H. Films which contained a combination of HCR and nucleating agent had the best improvement in various properties.

### Example 9

In Example 9, the core layer contained a core polymer and varying amounts of HCR. The sealant layer comprised a blend of JPC 7794 and varying amounts of Vistamaxx™ 3980. Table 22 shows the film structures of the sample films in Example 9. The films were tested for a variety of properties, with the results shown in Table G.

TABLE 22
Example 9 Film Structures

| | Outer Skin | | | | |
|---|---|---|---|---|---|
| | Layer | Core Layer | | Sealant layer | |
| | JPC 7510 | FF035C1 | PA-609 | JPC 7794 | VMX 3980 |
| Film 9A | 100% | 100% | 0% | 100% | 0% |
| Film 9B | 100% | 100% | 0% | 85% | 15% |
| Film 9C | 100% | 100% | 15% | 85% | 15% |
| Film 9D | 100% | 82% | 15% | 85% | 15% |
| Film 9E | 100% | 97% | 0% | 100% | 0% |

Samples 9A-9C were produced with Sunoco FF025FC1 resin in the core. Films containing this resin showed a slightly higher WVTR as compared to films containing FF025C2, which does not contain a nucleating agent. This could possibly be due to the fact that FF025C1 was not compounded in line when the resin was produced; instead it was compounded later to incorporate the nucleating agent. This extra compounding process could have caused some property changes in the resin.

TABLE A
Properties of Sample Films in Example 1

| | | | | | | | | | | Lako Seals | | |
|---|---|---|---|---|---|---|---|---|---|---|---|---|
| | | | | | | | | | | 60 psi, 0.75 sec dwell, | | |
| | | | | Tensile | | | | | | 20 sec cooling, | | |
| | | C/R Skin | Total Film | Modulus | | Elongation | | Ultimate | | vertical jaw | | |
| | Haze | Gauge | Gauge | (KPSI) | | (%) | | Tensile | | g/in | | |
| Film | % | μm | mil | MD | TD | MD | TD | MD | TD | 200° F. | 220° F. | 240° F. |
| A | 1.44 | 0.86 | 0.68 | 272 | 485 | 178 | 58 | 21 | 34 | 280 | 680 | 780 |
| B | 1.42 | 0.78 | 0.67 | 380 | 380 | 120 | 115 | 28 | 27 | 320 | 810 | 1000 |
| C | 1.18 | 0.95 | 0.66 | 274 | 485 | 173 | 56 | 22 | 34 | 350 | 860 | 1070 |
| D | 1.25 | 0.86 | 0.66 | 272 | 488 | 171 | 45 | 22 | 32 | 440 | 940 | 1160 |
| E | 1.15 | 1.11 | 0.66 | 273 | 466 | 175 | 64 | 22 | 33 | 390 | 830 | 1060 |
| F | 1.3 | | 07 | 289 | 474 | 150 | 54 | 20 | 33 | 361 | 486 | 377 |

| | Lako Seals | | Lako Hot Tack | | | | |
|---|---|---|---|---|---|---|---|
| | 60 psi, 0.75 sec | | 60 psi, 0.75 sec | | | | |
| | dwell, 20 sec | | dwell, 0 sec cooling, | | | | |
| | cooling, vertical | | vertical jaw | | | | |
| | jaw g/in | | g/in | | | | |
| Film | 260° F. | 280° F. | 200° F. | 220° F. | 240° F. | 260° F. | 280° F. |
| A | 1110 | 1420 | 173 | 315 | 440 | 460 | 455 |
| B | 1220 | 1180 | 190 | 360 | 400 | 410 | 460 |
| C | 1370 | 870 | 356 | 416 | 361 | 410 | 155 |
| D | 1350 | 1200 | 220 | 400 | 405 | 400 | 425 |
| E | 1000 | 1120 | 296 | 450 | 440 | 308 | 275 |
| F | 679 | 969 | 258 | 435 | 328 | 310 | 264 |

TABLE B
Properties of Sample Films in Example 2

| | |
|---|---|
| | Lako Seals |
| | 60 psi, |
| | 0.75 sec dwell, |
| Tensile | 20 sec cooling, |

| | | C/R Skin | Total Film | Modulus | | Elongation | | Ultimate | | vertical jaw | |
|---|---|---|---|---|---|---|---|---|---|---|---|
| | Haze | Gauge | Gauge | (KPSI) | | (%) | | Tensile | | g/in | |
| Film | % | μm | mil | MD | TD | MD | TD | MD | TD | 200° F. | 220° F. |
| G | 0.92 | 0.99 | 0.64 | 289 | 502 | 168 | 57 | 22 | 34 | 42 | 58 |
| H | 1.04 | 1 | 0.65 | 285 | 490 | 162 | 63 | 22 | 34 | 38 | 120 |
| I | 1.07 | 0.86 | 0.64 | 263 | 474 | 177 | 50 | 22 | 32 | 81 | 450 |
| J | 0.98 | 1.03 | 0.65 | 278 | 472 | 180 | 68 | 22 | 33 | 35 | 110 |
| K | 0.91 | 1.1 | 0.66 | 265 | 423 | 165 | 72 | 21 | 33 | 46 | 250 |
| L | 0.9 | | 0.7 | 284 | 502 | 156 | 65 | 21 | 35 | 52 | 329 |

| | Lako Seals | | | Lako Hot Tack | | | |
|---|---|---|---|---|---|---|---|
| | 60 psi, 0.75 sec dwell, | | | 60 psi, 0.75 sec | | | |
| | 20 sec cooling, | | | dwell, 0 sec | | | |
| | vertical jaw | | | cooling, vertical jaw | | | |
| | g/in | | | g/in | | | |
| Film | 240° F. | 260° F. | 280° F. | 220° F. | 240° F. | 260° F. | 280° F. |
| G | 830 | 620 | 570 | 64 | 430 | 430 | 400 |
| H | 1120 | 750 | 1010 | 125 | 420 | 420 | 500 |
| I | 1030 | 1020 | 1320 | 225 | 300 | 300 | 235 |
| J | 560 | 850 | 860 | 115 | 470 | 470 | 456 |
| K | 1040 | 1210 | 1240 | 176 | 307 | 307 | 345 |
| L | 478 | 702 | 571 | 182 | 380 | 360 | 258 |

TABLE C
Properties of Sample Films in Example 3

| | |
|---|---|
| | Lako Seals |
| | 60 psi, |
| | 0.75 sec dwell, |
| Tensile | 20 sec cooling, |

| | | C/R Skin | Total Film | Modulus | | Elongation | | Ultimate | | vertical jaw | |
|---|---|---|---|---|---|---|---|---|---|---|---|
| | Haze | Gauge | Gauge | (KPSI) | | (%) | | Tensile | | g/in | |
| Film | % | μm | mil | MD | TD | MD | TD | MD | TD | 200° F. | 220° F. |
| M | | | | | | | | | | | 44 |
| N | 0.83 | 0.81 | 0.65 | 259 | 480 | 170 | 67 | 22 | 36 | 46 | 72 |
| O | 0.95 | 1.02 | 0.66 | 278 | 470 | 176 | 66 | 22 | 35 | 46 | 106 |
| P | 0.82 | 0.99 | 0.65 | 279 | 475 | 175 | 67 | 22 | 35 | 39 | 54 |
| Q | 0.76 | 1 | 0.64 | 279 | 472 | 169 | 63 | 22 | 35 | 41 | 110 |
| R | 0.9 | | 0.7 | 284 | 481 | 147 | 53 | 19 | 33 | | 62 |

| | Lako Seals | | | Lako Hot Tack | | | |
|---|---|---|---|---|---|---|---|
| | 60 psi, 0.75 sec dwell, | | | 60 psi, 0.75 sec | | | |
| | 20 sec cooling, | | | dwell, 0 sec | | | |
| | vertical jaw | | | cooling, vertical jaw | | | |
| | g/in | | | g/in | | | |
| Film | 240° F. | 260° F. | 280° F. | 220° F. | 240° F. | 260° F. | 280° F. |
| M | 400 | 350 | 390 | | 157 | 149 | 151 |
| N | 500 | 1030 | 780 | 55 | 303 | 435 | 396 |
| O | 580 | 1320 | 960 | 99 | 369 | 339 | 330 |
| P | 590 | 855 | 610 | 60 | 278 | 423 | 363 |
| Q | 720 | 1200 | 1170 | 150 | 342 | 449 | 307 |
| R | 527 | 533 | 512 | 97 | 271 | 449 | 373 |

TABLE D
Properties of Sample Films in Example 4

| | |
|---|---|
| | Lako Seals |
| | 60 psi, 0.75 sec dwell, |
| Tensile | 20 sec cooling, |

| | | Total Film | Modulus | | Elongation | | Ultimate | | vertical jaw | | |
|---|---|---|---|---|---|---|---|---|---|---|---|
| | Haze | Gauge | (KPSI) | | (%) | | Tensile | | g/in | | |
| Film | % | mil | MD | TD | MD | TD | MD | TD | 220° F. | 230° F. | 240° F. |
| AA | 0.9 | 0.72 | 321 | 558 | 22 | 37 | 166 | 47 | 73 | 150 | 590 |
| BB | 0.9 | 0.73 | 314 | 584 | 23 | 39 | 177 | 54 | 73 | 439 | |
| CC | 0.9 | 0.76 | 304 | 528 | 20 | 36 | 166 | 63 | 166 | 626 | |
| DD | 1.6 | 0.76 | 308 | 537 | 21 | 37 | 171 | 61 | 76 | 203 | 428 |
| EE | 3.3 | 0.75 | 313 | 520 | 21 | 38 | 169 | 63 | 88 | 274 | |
| FF | 2.6 | 0.78 | 301 | 531 | 21 | 37 | 167 | 60 | 63 | 182 | 529 |
| GG | 6.0 | 0.78 | 302 | 529 | 21 | 36 | 170 | 52 | 71 | 258 | |

| | Lako Seals | | | | Lako Hot Tack | | | | |
|---|---|---|---|---|---|---|---|---|---|
| | 60 psi, 0.75 sec dwell, | | | | 60 psi, 0.75 sec dwell, | | | | |
| | 20 sec cooling, | | | | 0 sec cooling, | | | | |
| | vertical jaw | | | | vertical jaw | | | | |
| | g/in | | | MST | g/in | | | | |
| Film | 250° F. | 260° F. | 280° F. | ° F. | 220° F. | 230° F. | 240° F. | 250° F. | 270° F. |
| AA | 460 | 452 | 410 | 235 | 83 | 205 | 341 | 330 | 380 |
| BB | 435 | 470 | | 223 | 122 | 239 | 379 | 337 | 396 |
| CC | 466 | 500 | | 221 | 172 | 303 | 383 | 365 | 423 |
| DD | 514 | 573 | | 230 | | 197 | 324 | 308 | 419 |
| EE | 605 | 663 | | 226 | 121 | 225 | 303 | 370 | 441 |
| FF | | 670 | | 231 | | 182 | 293 | 310 | 413 |
| GG | 683 | 849 | | 226 | 116 | 206 | 328 | 383 | 425 |

TABLE E
Properties of Sample Films in Example 5

| | | | | | | | | | Lako Seals | | | | | Lako Hot Tack | | | |
|---|---|---|---|---|---|---|---|---|---|---|---|---|---|---|---|---|---|
| | | | | | | | | | 60 psi, 0.75 sec dwell, 20 sec | | | | | 60 psi, 0.75 sec dwell, | | | |
| | | | Tensile | | | | | | cooling, | | | | | 0 sec cooling, | | | |
| | | Total Film | Modulus | | Elongation | | Ultimate | | vertical jaw | | | | | vertical jaw | | | |
| | Haze | Gauge | (KPSI) | | (%) | | Tensile | | g/in | | | | MST | g/in | | | |
| Film | % | mil | MD | TD | MD | TD | MD | TD | 230° F. | 240° F. | 250° F. | 260° F. | ° F. | 240° F. | 250° F. | 260° F. | 270° F. |
| HH | 11.4 | 0.72 | 302 | 492 | 21 | 35 | 159 | 49 | 31 | 80 | 298 | 634 | 246 | 73 | 314 | | 496 |
| II | 10.3 | 0.70 | 292 | 531 | 22 | 37 | 172 | 67 | 58 | 108 | 430 | 880 | 243 | 117 | 281 | | 510 |
| JJ | 1.5 | 0.70 | 306 | 527 | 21 | 38 | 156 | 56 | 70 | 156 | 455 | 793 | 242 | 150 | 255 | | 495 |
| KK | 11.9 | 0.70 | 303 | 497 | 22 | 37 | 167 | 57 | 56 | 89 | 264 | 687 | 246 | 84 | 227 | | 530 |
| LL | 11.7 | 0.70 | 288 | 515 | 21 | 37 | 172 | 57 | 65 | 116 | 296 | 506 | 245 | 110 | 234 | | 484 |
| MM | 28.3 | 0.70 | 299 | 538 | 22 | 37 | 167 | 55 | 62 | 92 | 157 | 392 | 252 | | 186 | 367 | 333 |
| NN | 26.8 | 0.72 | 296 | 504 | 21 | 37 | 163 | 61 | 66 | 98 | 170 | 296 | 252 | | 156 | 340 | 328 |

TABLE F
Properties of Sample Films in Example 8

| | |
|---|---|
| | Lako Seals |
| | 60 psi, 0.75 sec |
| Tensile | dwell, 20 sec cooling, |

| | | | | Modulus | | Elongation | | Ultimate | | vertical jaw | | |
|---|---|---|---|---|---|---|---|---|---|---|---|---|
| | Haze | | Total Film | (KPSI) | | (%) | | Tensile | | g/in | | |
| Film | % | WVTR | Gauge | MD | TD | MD | TD | MD | TD | 170° F. | 180° F. | 190° F. |
| 8A | 1.81 | 5.99 | 0.70 | 20 | 33 | 143 | 50 | 304 | 519 | | | 111 |
| 8B | 1.48 | 7.67 | 0.70 | 20 | 33 | 155 | 53 | 280 | 463 | | 210 | 255 |
| 8C | 1.75 | 7.56 | 0.68 | 21 | 34 | 160 | 64 | 297 | 504 | | | 171 |
| 8D | 1.56 | 5.51 | 0.68 | 19 | 29 | 170 | 48 | 313 | 556 | | 70 | 202 |
| 8E | 1.39 | 5.88 | 0.65 | 21 | 32 | 173 | 53 | 327 | 584 | 143 | 270 | 372 |
| 8F | 1.49 | 5.46 | 0.65 | 20 | 32 | 187 | 64 | 335 | 572 | 150 | 378 | 644 |
| 8G | 1.35 | 4.97 | 0.65 | 20 | 32 | 184 | 58 | 324 | 585 | | 119 | 395 |
| 8H | 1.4 | 5.43 | 0.66 | 20 | 32 | 188 | 65 | 324 | 584 | | 52 | 300 |
| 8I | 1.98 | 7.34 | 0.65 | 22 | 37 | 171 | 58 | 299 | 567 | | 44 | 203 |

| | Lako Seals | | | Lako Hot Tack | | | | | |
|---|---|---|---|---|---|---|---|---|---|
| | 60 psi, 0.75 sec | | | 60 psi, 0.75 sec dwell, | | | | | |
| | dwell, 20 sec | | | 0 sec cooling, | | | | | |
| | cooling, vertical | | | vertical jaw | | | | | |
| | jaw g/in | | MST | g/in | | | | | |
| Film | 200° F. | 220° F. | ° F. | 170° F. | 180° F. | 190° F. | 200° F. | 220° F. | 240° F. |
| 8A | 280 | 497 | 196 | | | | 184 | 306 | 404 |
| 8B | 402 | 590 | 180 | | 163 | 224 | 330 | 422 | 376 |
| 8C | 349 | 596 | 192 | | | | 211 | 361 | 361 |
| 8D | 353 | 647 | 190 | | | | 219 | 305 | 294 |
| 8E | 424 | 610 | 175 | 155 | 201 | 289 | 310 | 357 | 321 |
| 8F | 638 | 750 | 172 | 198 | 262 | 246 | 430 | 476 | 365 |
| 8G | 505 | 806 | 183 | 161 | 203 | 274 | 340 | 438 | 379 |
| 8H | 490 | 870 | 186 | 109 | 161 | 188 | 246 | 412 | 399 |
| 8I | 302 | 457 | 190 | | | | 173 | 319 | 450 |

TABLE G
Properties of Sample Films in Example 9

| | |
|---|---|
| | Lako Seals |
| | 60 psi, |
| | 0.75 sec dwell, |
| Tensile | 20 sec cooling, |

| | | | | Modulus | | Elongation | | Ultimate | | vertical jaw | |
|---|---|---|---|---|---|---|---|---|---|---|---|
| | Haze | | Total Film | (KPSI) | | (%) | | Tensile | | g/in | |
| Film | % | WVTR | Gauge | MD | TD | MD | TD | MD | TD | 180° F. | 190° F. |
| 9A | 6.63 | 6.63 | 0.70 | 20 | 34 | 184 | 47 | 318 | 591 | | 189 |
| 9B | 6.52 | 6.52 | 0.67 | 20 | 35 | 179 | 54 | 316 | 570 | 60 | 315 |
| 9C | 4.84 | 4.84 | 0.68 | 19 | 29 | 208 | 63 | 335 | 561 | 69 | 365 |
| 9D | 4.35 | 4.35 | 0.68 | 22 | 34 | 195 | 55 | 349 | 622 | 60 | 208 |
| 9E | 5.74 | 5.74 | 0.70 | 21 | 38 | 171 | 46 | 310 | 606 | 48 | 201 |

| | Lako Seals | | | Lako Hot Tack | | | | |
|---|---|---|---|---|---|---|---|---|
| | 60 psi, 0.75 sec | | | 60 psi, 0.75 sec dwell, | | | | |
| | dwell, 20 sec | | | 0 sec cooling, | | | | |
| | cooling, vertical | | | vertical jaw | | | | |
| | jaw g/in | | MST | g/in | | | | |
| Film | 200° F. | 220° F. | ° F. | 180° F. | 190° F. | 200° F. | 220° F. | 240° F. |
| 9A | 336 | 443 | 191 | | | 195 | 328 | 393 |
| 9B | 368 | 699 | 186 | 150 | 191 | 256 | 418 | 370 |
| 9C | 510 | 599 | 184 | 175 | 221 | 290 | 382 | 339 |
| 9D | 307 | 507 | 190 | | | 208 | 262 | 281 |
| 9E | 315 | 463 | 190 | | | 176 | 320 | 375 |

### Example 10

### Producing an Image on Multilayered Films

A 5-layer film having an A/B/C/D/E structure was tested: “A” layer is a 85/15 wt/wt blend of a high crystallinity polypropylene (Total 3270) and a Vistamaxx propylene-based elastomer, having 9 wt % ethylene by weight of the elastomer and a melting point of 79° C.; “B” layer is a polypropylene; “C” layer is polypropylene; “D” layer is a blend of high crystallinity polypropylene as in the A layer with about 6 wt % CaCO₃ from a masterbatch and about 7 wt % TiO₂ from a different masterbatch; and layer “E” is an EPB terpolymer (Japan Polypropylene 7794). Note that there is no pigment in this sample. Layers A, B, C, and E are clear. When the cavitated tie layer D was collapsed in a pattern in the printer, the image occurs in the clear areas framed by the white layer. The sample was placed on a dark background to illustrate the effect of an internal pigmented layer.

The imaging test was run under the following conditions: Thermal Transfer Printer—Zebra™ Model 140xi4, speed was 2 inches per second, relative darkness setting (temperature) was set at 17, the scale running from 0 to 30. The heat from the printing head is applied on the “E” layer of the film. The results of testing are in Table H.

TABLE H
Thermal Printer Testing of Inventive Imageable Film
PRINTER ZEBRA 140xi4

| | | Resulting visual |
|---|---|---|
| Speed | reference darkness setting | image of barcode (type 39) |
| inch/sec | (0 low to 30 high) | 1 TO 5 (5 = best) |
| 2 | 12 | 1 |
| 2 | 14 | 1 |
| 2 | 16 | 1 |
| 2 | 18 | 3 |
| 2 | 20 | 3 |
| 2 | 22 | 4 |
| 2 | 24 | 4 |
| 2 | 26 | 5 |
| 2 | 28 | 5 |
| 4 | 28 | 3 |
| 4 | 30 | 3 |
| 6 | 28 | 1 |

Having described the imageable films and the methods of making such films, disclosed herein in numbered embodiments are:
1. An imageable multilayer film comprising (or consisting essentially of, consisting of):
   a) a polypropylene core layer that is clear or comprises a pigment or colorant;
   b) a clear sealant layer through which an image may be visible; and
   c) at least one image-side tie layer, wherein the image-side tie layer is intermediate of the core layer and the sealant layer and comprises a cavitating agent.
2. The multilayer film of numbered embodiment 1, wherein the sealant layer has a Haze Value (ASTM D1003) of less than 10% or 8% or 5% or 2%.
3. The multilayer film of numbered embodiments 1 or 2, wherein colorants, pigments, and opacifying agents are substantially absent from the image-side tie layer.
4. The multilayer film of any one of the previous numbered embodiments, wherein the image-side tie layer has contracted to within the range of from 0.1% or 0.5% or 1% or 2% or 5% to 6% or 10% or 15% of its original thickness upon collapse of the voids created by the cavitating agent in the areas where an image is effected.
5. The multilayer film of any one of the previous numbered embodiments, wherein the sealant layer comprises a first polymer component (FPC), a second polymer component (SPC), or a combination thereof.
6. The multilayer film of numbered embodiment 5, wherein the second polymer component has a density in the range of 0.850 g/cm³ to 0.920 g/cm³, a DSC melting point in the range of 40° C. to 160° C., and a melt flow rate in the range of 2 dg/min to 100 dg/min.
7. The multilayer film of numbered embodiment 5, wherein first polymer component has a ΔH in the range of from about 50 J/g to about 75 J/g.
8. The multilayer film of any one of the previous numbered embodiments, wherein at least one of said film's outermost surface is treated with at least one treatment comprising at least one of corona discharge, flame treatment, plasma treatment, chemical treatment, and treatment by means of a polarized flame.
9. The multilayer film of any one of the previous numbered embodiments, wherein said film is coated with at least one coating comprising at least one of ethylene acrylic acid, ethylene methyl acrylate copolymers, polyvinylidene chloride, polyvinyl alcohol, ethyl vinyl alcohol, pigments or colorants, or a combination of any of these.
10. The multilayer film of any one of the previous numbered embodiments, wherein coatings (and/or inks) are substantially absent from the sealant layer side of the multilayer film, and most preferably, from both sides of the multilayered film.
11. The multilayer film of any one of the previous numbered embodiments, wherein the film is treated with a device that imparts selective physical or thermal treatment to the image-side of the film to effect an image.
12. The multilayer film of any one of the previous numbered embodiments, wherein cavitation agents are substantially absent from the core layer.
13. The multilayer film of any one of the previous numbered embodiments, wherein the sealant layer has a thickness within the range from 0.10 μm to 7 μm, the image-side tie layer a thickness within the range from 0.50 μm to 12 μm, and the core layer a thickness within the range from 20 μm to 50 μm.
14. The multilayer film of any one of the previous numbered embodiments, wherein the film is biaxially oriented.
15. A package formed from the multilayer film of any one of the previous numbered embodiments.
16. A method forming an image on a multilayer film of any one of the previous numbered embodiments comprising (or consisting essentially of, or consisting of) the steps of:
   a) co-extruding at least;
      i) core layer;
      ii) a sealant layer;
      iii) an image-side tie layer, wherein the image-side tie layer is intermediate the core layer and the sealant layer;
   b) orienting said co-extruded multilayer film in at least one direction; and
   c) imparting selective physical or thermal treatment to the image-side of the film to effect an image thereon.
17. The method of numbered embodiment 16, further comprising forming a package by enclosing a product or article within at least a portion of the co-extruded film;
   engaging a first portion of the sealant layer with a second portion of the sealant layer at a seal area; and
   applying pressure and heat at the seal area to cause the first portion to engage with the second portion to create at least one of a fin seal, a lap seal, and a crimp seal in the seal area.
18. The method of numbered embodiment 16 or 17, wherein the core layer comprises a colorant or pigment.
19. The method of any one of numbered embodiments 16 to 18, wherein the image-side tie layer comprises a colorant or pigment.
20. The method of any one of numbered embodiments 16 to 19, wherein a colored coating or metal coating is placed on the outside surface of the second skin layer of the multilayered film that is opposite the sealant layer.
21. The method of any one of numbered embodiments 16 to 20, wherein the sealant layer comprises a first polymer component (FPC), a second polymer component (SPC), or a combination thereof
22. The method of any one of numbered embodiments 16 to 21, wherein the second polymer component has a density in the range of 0.850 g/cm³ to 0.920 g/cm³, a DSC melting point in the range of 40° C. to 160° C., and a melt flow rate in the range of 2 dg/min to 100 dg/min.
23. The method of any one of numbered embodiments 16 to 22, wherein the step of imparting causes the image-side tie layer to contract within the range of from 0.1% or 0.5% or 1% or 2% or 5% to 6% or 10% or 15% of its original thickness upon collapse of the voids created by the cavitating agent in the areas where an image is effected.

Also disclosed is the use of the imageable film of any one of the numbered embodiments above in packaging.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

What we claim is:

1. An imageable multilayer film comprising:
a) a polypropylene core layer that is clear or comprises a pigment or colorant; and
b) a clear sealant layer through which an image may be visible; and
c) at least one image-side tie layer, wherein the image-side tie layer is intermediate of the core layer and the sealant layer and comprises a cavitating agent.

2. The multilayer film of claim 1, wherein the sealant layer has a Haze Value (ASTM D1003) of less than 10% or 8% or 5% or 2%.

3. The multilayer film of claim 1, wherein colorants, pigments, and opacifying agents are substantially absent from the image-side tie layer.

4. The multilayer film of claim 1, wherein the image-side tie layer has contracted to within the range of from 0.1% to 15% of its original thickness upon collapse of the voids created by the cavitating agent in the areas where an image is effected.

5. The multilayer film of claim 1, wherein the sealant layer comprises a first polymer component (FPC), a second polymer component (SPC), or a combination thereof.

6. The multilayer film of claim 5, wherein the second polymer component has a density in the range of 0.850 g/cm³ to 0.920 g/cm³, a DSC melting point in the range of 40° C. to 160° C., and a melt flow rate in the range of 2 dg/min to 100 dg/min.

7. The multilayer film of claim 5, wherein first polymer component has a ΔH in the range of from about 50 J/g to about 75 J/g.

8. The multilayer film of claim 1, wherein at least one of said multilayer film's outermost surface is treated with at least one treatment comprising at least one of corona discharge, flame treatment, plasma treatment, chemical treatment, and treatment by means of a polarized flame.

9. The multilayer film of claim 1, wherein said multilayer film is coated with at least one coating comprising at least one of ethylene acrylic acid, ethylene methyl acrylate copolymers, polyvinylidene chloride, polyvinyl alcohol, ethyl vinyl alcohol, pigments or colorants, or a combination of any of these.

10. The multilayer film of claim 1, wherein coatings are substantially absent from the sealant layer side of the multilayer film.

11. The multilayer film of claim 1, wherein the film is treated with a device that imparts selective physical or thermal treatment to the image-side of the multilayer film to affect an image.

12. The multilayer film of claim 1, wherein the multilayer film is biaxially oriented.

13. A package formed from the multilayer film of claim 1.

14. A method forming an image on a multilayer film comprising the steps of:
a) co-extruding at least;
i) core layer;
ii) a sealant layer;
iii) an image-side tie layer, wherein the image-side tie layer is intermediate the core layer and the sealant layer, thus forming a multilayer film;
b) orienting said multilayer film in at least one direction; and
c) imparting selective physical or thermal treatment to the image-side of the multilayer film to effect an image thereon.

15. The method of claim 14, further comprising forming a package by enclosing a product or article within at least a portion of the multilayer film;
engaging a first portion of the sealant layer with a second portion of the sealant layer at a seal area; and
applying pressure and heat at the seal area to cause the first portion to engage with the second portion to create at least one of a fin seal, a lap seal, and a crimp seal in the seal area.

16. The method of claim 14, wherein the core layer comprises a colorant or pigment.

17. The method of claim 14, wherein colorants, pigments, and opacifying agents are substantially absent from the image-side tie layer.

18. The method of claim 14, wherein a colored coating or metal coating is placed on the multilayered film surface opposite the sealant layer.

19. The method of claim 14, wherein the sealant layer comprises a first polymer component (FPC), a second polymer component (SPC), or a combination thereof.

20. The method of claim 19, wherein the second polymer component has a density in the range of 0.850 g/cm³ to 0.920 g/cm³, a DSC melting point in the range of 40° C. to 160° C., and a melt flow rate in the range of 2 dg/min to 100 dg/min.

21. The method of claim 14, wherein the imparting causes the image-side tie layer to contract within the range of from 0.1% to 15% of its original thickness upon collapse of the voids created by the cavitating agent in the areas where an image is effected.
